(19) United States
(12) Patent Application Publication
(10) Pub. No.: US 2007/0132205 A1
(43) Pub. Date: Jun. 14, 2007

(54) TRAILER

(76) Inventors: David C. Winter, Layton, UT (US); BRANDON SMITH, S. Ogden, UT (US); Mitch Johnson, S. Weber, UT (US); Jered Larsen, Bountiful, UT (US); Robert A. Astle, Farmington, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/609,323

(22) Filed: Dec. 11, 2006

Related U.S. Application Data
(60) Provisional application No. 60/749,775, filed on Dec. 12, 2005.
(60) Provisional application No. 60/752,194, filed on Dec. 20, 2005.
(60) Provisional application No. 60/777,760, filed on Mar. 1, 2006.
(60) Provisional application No. 60/810,088, filed on Jun. 1, 2006.
(60) Provisional application No. 60/840,849, filed on Aug. 29, 2006.
(60) Provisional application No. 60/840,893, filed on Aug. 29, 2006.

(51) Int. Cl. B62D 53/06

(52) U.S. Cl. 280/441.2; 280/491.5

(57) ABSTRACT

A trailer may be purchased by a consumer from a store and the trailer may be quickly, easily and readily towed away from the store. In particular, the trailer may be essentially or completely ready to be towed away from the store and the trailer may require no or virtually no assembly. For example, a towing arm may be quickly and easily moved from the storage position to the use position. Advantageously, because the towing arm may be connected by pins to the trailer, no tools may be required to position the arm in the use position. In addition, because electrical wiring may be disposed within the arm and the arm may be simply moved forwardly when the trailer is ready to be towed, the lights for the trailer may be functional.

### CROSS-REFERENCE TO RELATED APPLICATIONS

This application claims priority to, and the benefit of, U.S. provisional patent application Ser. No. 60/749,775, filed Dec. 12, 2005 and entitled TRAILER.

This application claims priority to, and the benefit of, U.S. provisional patent application Ser. No. 60/752,194, filed Dec. 20, 2005 and entitled TRAILER.

This application claims priority to, and the benefit of, U.S. provisional patent application Ser. No. 60/777,760, filed Mar. 1, 2006 and entitled TRAILER.

This application claims priority to, and the benefit of, U.S. provisional patent application Ser. No. 60/810,088, filed Jun. 1, 2006 and entitled TRAILER.

This application claims priority to, and the benefit of, U.S. provisional patent application Ser. No. 60/840,849, entitled TRAILER and filed Aug. 29, 2006.

This application claims priority to, and the benefit of, U.S. provisional patent application Ser. No. 60/840,893, entitled TRAILER and filed Aug. 29, 2006.

The disclosures of each of these applications are incorporated by reference in their entireties.

### BACKGROUND OF THE INVENTION

1. Field of the Invention

The present invention generally relates to storage and/or transportation systems and, in particular, to trailers.

2. Description of Related Art

Conventional trailers may be attached to an automobile to allow the automobile to tow the trailer. Some known trailers have a relatively large size, which may allow the trailer to hold a large number of items or larger items. These relatively large trailers, however, may be difficult to maneuver and store. Other known trailers may have a relatively small size, which may be more easily maneuvered and stored than larger trailers. Disadvantageously, the smaller trailers may not be able to hold as many items and/or as large of items as the larger trailers.

Conventional trailers typically include a rear gate that swings downwardly or to the side. The downwardly swinging rear gates may provide a ramp for easier access to the trailer, which may allow the trailer to be loaded and unloaded more quickly and easily. The downwardly swinging rear gates, however, can be relatively heavy and that may make it difficult to lower and to lift the gates. The side swinging rear gates, on the other hand, are typically easier to open and close. The side swinging rear gates, however, can make the trailer more difficult to load and unload than trailers with downwardly swinging rear gates that create ramps.

### BRIEF SUMMARY OF EMBODIMENTS OF THE INVENTION

A need therefore exists for a trailer that eliminates or diminishes the disadvantages and problems described above.

One aspect of the invention is a trailer that may be used to store and/or transport items. For example, an automobile or vehicle may pull or otherwise move the trailer to transport items carried by the trailer. The trailer may include a frame, a bed and an arm that may be sized and configured to be connected to the vehicle. In particular, the vehicle may include a hitch and the arm may be sized and configured to be attached to the hitch. It will be appreciated that the trailer may be connected to the vehicle in any suitable manner and using other appropriate connectors and/or structures.

Another aspect is a trailer that may include an arm that may be selectively moved between different positions. For example, the arm may be selectively moved between a use or extended position and a storage or retracted position. Advantageously, when the arm is in a storage or retracted position, the trailer may take up less space and may be more efficiently stored and/or shipped. Desirably, when the arm is in the storage or retracted position, all or at least a substantial portion of the length of the arm is disposed behind the front of the frame and/or bed of the trailer. In addition, all or at least a substantial portion of the length of the arm is preferably disposed underneath the frame and/or the bed of the trailer when the arm is in the storage or retracted position.

Still another aspect is a trailer that may include an arm that may be selectively connected to the trailer. For example, the arm may be selectively connected to the trailer by fasteners such as bolts, rivets, screws, pins and the like. The arm may also be connected to the trailer by a snap, friction or interference fit, and the like. Advantageously, this may allow the arm to be quickly and easily moved between the use or extended position and the storage or retracted position.

Yet another aspect is a trailer that may include flanges which may be used to connect the arm to the frame. For example, the frame may include a first pair of flanges and a second pair of flanges. The arm may be connected to the first pair of flanges and/or the second pair of flanges depending, for example, upon the desired positioning of the arm. Advantageously, the flanges may facilitate selectively connecting the arm to the trailer.

A further aspect is a trailer that may include one or more walls, gates or barriers, which may be used to help position and/or store items within the trailer. For example, the trailer may include a front barrier, a rear barrier, a left barrier and a right barrier. The trailer may also include a bed to facilitate transporting items in the trailer. It will be appreciated that the barriers and/or bed may have a variety of suitable shapes, sizes and configurations depending, for example, upon the intended use of the trailer.

A still further aspect is a trailer that may include one or more barriers that may pivot or otherwise move relative to the trailer. For example, the rear barrier may move between a closed position and an opened position to facilitate access to the bed of the trailer. The front barrier may also move between closed and open positions to facilitate access to the bed of the trailer. In addition, the front barrier may pivot or move forwardly and/or upwardly to allow for longer items (such as large pieces of plywood or drywall) to extend past the front edge of the bed. If desired, the front barrier may be selectively disconnected to allow such items to extend past the front edge of the bed. In addition, the other barriers may be moved or disconnected to allow larger items to be transported by the trailer.

Another aspect is a trailer that may include one or more barriers which may be movable between use and collapsed positions. Advantageously, when the barriers are disposed in the collapsed position, that may allow the trailer be more efficiently stored and/or shipped. For example, the barriers may be selectively pivoted, moved or disconnected from the trailer when the barriers are disposed in the collapsed position.

Still another aspect is a trailer that may include a rear barrier or gate that may move or pivot downwardly and sideways relative to the trailer. For example, the rear barrier may be pivoted downwardly to create a ramp for easy access to the trailer. In addition, the rear barrier may be pivoted to the side to provide easy access to the trailer. Desirably the user can quickly and easily move the gate downwardly or to the side depending, for example, upon how it is desired to load or unload the trailer.

Yet another aspect is a trailer that may include a rear barrier and pins which are sized and configured to allow the rear barrier to pivot downwardly and/or sideways. For example, the trailer may include an upper left pin, an upper right pin, a lower left pin and a lower right pin. The pins are preferably movable between a locked position and an unlocked position. For example, the upper left and upper right pins may be moved upwardly to unlocked positions, which may allow the rear barrier to pivot downwardly about the lower left and lower right pins. Also, for example, the upper right and lower right pins may be respectively moved upwardly and laterally to unlocked positions, which may allow the rear barrier to pivot sideways about the upper left and lower left pins. The lower left pin preferably has a generally L-shaped configured including a first portion about which the rear barrier may pivot downwardly and a second portion about which the rear barrier may pivot sideways. The upper left pin is preferably positioned proximate the middle of the rear barrier and is also preferably axially aligned with the second portion of the lower left pin to help allow the rear barrier to pivot sideways. It will be appreciated that the trailer may include other suitable numbers and arrangements of pins. It will also be appreciated that the pins may be located in a variety of locations and may have other appropriate sizes, shapes and/or configurations, depending, for example, upon the intended use of the trailer.

Advantageously, the rear barrier which may be quickly and easily disconnected from the trailer. For example, if the rear barrier is connected to the trailer by the upper left pin, upper right pin, lower left pin and lower right pin, then the barrier may be quickly and easily disconnected from the trailer. In particular, to remove the rear barrier, the upper right and lower right pins may be respectively moved upwardly and laterally to unlocked positions, which may allow the rear barrier to pivot sideways about the upper left and lower left pins. Next, the upper left pin may be moved may be moved upwardly to an unlocked position and the rear barrier may be moved away from the lower left pin to slidably disconnect the rear barrier from the lower left pin.

Significantly, this may allow a three-way gate to be created. In particular, the gate may move horizontally or sideways, vertically and the gate may be removed. Desirably, the three-way gate can be used without requiring the use of any tools. Additionally, the gate may be lockable if desired.

A further aspect is a trailer that may include one or more biasing members to bias the pins into the locked and/or unlocked positions. In particular, the biasing members are preferably sized and configured to bias the pins into the locked position. For example, a spring may be used to bias the pin into the locked position. Significantly, the biasing members may allow the pins to automatically lock the rear barrier into the desired position.

A still further aspect is a trailer that may include a bed with interlocking and/or overlapping portions. For example, the bed may include a first portion with a corrugated configuration and a second portion with a corrugated configuration. The first and second portions may interlock and/or overlap, if desired. The bed is preferably constructed from metal, such as steel, and the interlocking and/or overlapping portions may be connected by fasteners, adhesives, welding, snap fit, friction fit, interference fit or the like. Advantageously, the multiple components may help disperse impacts and forces applied to the bed, which may help prevent damage to the trailer. The overlapping and/or interlocking portions may also help reinforce and strengthen the trailer.

Another further aspect is a trailer that may include barriers with interlocking and/or overlapping portions. For example, the barriers may include components that interlock and/or overlap. In particular, portions of the barriers may have a corrugated configuration and all or a portion of these corrugated sections may interlock and/or overlap. The barriers are preferably constructed from metal, such as steel, and the various components of the barriers may be connected by fasteners, adhesives, welding, snap fit, friction fit, interference fit or the like. In addition, the multiple components may help disperse impacts and forces applied to the barriers and that may help prevent damage to the barriers. Further, the overlapping and/or interlocking components may help reinforce and strengthen the barriers.

Still another aspect is trailer that may include a bed which is treated with a surface finish. Advantageously, the surface finish may reduce or prevent damage to the trailer. The surface finish may also help interconnect the components used to construct the bed. The surface finish may be applied, for example, by spraying a coating or layer of material on the bed. The surface finish may be constructed from rubber, elastomeric materials and/or other suitable materials having appropriate properties and characteristics. It will be appreciated that the surface finish may be applied by a variety of suitable processes.

Yet another aspect is a trailer that may include a front barrier with a front wall and side walls. The side walls are preferably tapered toward the sides of the trailer. Advantageously, the tapered portions may help prevent the trailer from unintentionally colliding with a vehicle pulling the trailer. In particular, the tapered portions may increase the distance between the trailer and the vehicle as the vehicle is turning, which may allow a greater turning radius. It will be appreciated that the trailer and tapered portions may have a variety of sizes and shapes which may provide, for example, a greater turning radius.

A further aspect is a trailer that may be purchased by a consumer from a store and the trailer can be quickly, easily and readily towed away from the store. In particular, the trailer may be essentially or completely ready to be towed away from the store and the trailer may require no or virtually no assembly. For example, the towing arm may be quickly and easily moved from the storage position to the use position. Advantageously, the arm may be connected by pins and no tools may be required to position the arm in the use position. In addition, because electrical wiring may be disposed within the arm and the arm may be simply moved forwardly, the trailer may have the required wiring whether the arm is in the use or storage positions. Thus, a consumer may purchase the trailer from a store and the trailer may be disposed in the storage position. The consumer, in order to transport the trailer from the store, may simply move the arm from the storage to the use position, connect the trailer to the vehicle that is to tow the trailer and connect the wiring as desired. Therefore, no tools may be required to initially drive the trailer from the store and if electrical power is supplied to the trailer, items such as the rear lights may be functional and the trailer may be driven on the road.

A still further aspect is a trailer that may include an extension. Advantageously, the extension may allow the trailer to be shipped at a standard size and/or within a standard-sized container. In particular, the trailer may be efficiently shipped within a ninety-two (92) inch container (2.33 meters). The extension also extends the length of the trailer. For example, the extension may allow the trailer to hold items that are about ninety-eight (98) inches (2.49 meters) in length. Thus, the trailer may be used to haul items that are 98 inches or approximately eight feet in length, such as four feet by eight feet pieces of plywood or drywall.

Another aspect is a trailer that may include a load indicator which indicates the amount of load carried by the trailer. Advantageously, the load indicator may have a relatively few number of components and it may be connected to a portion of the suspension system, such as the springs.

Still another aspect is a trailer that may include one or more tie downs that are preferably sized and configured to allow ropes, chains, lines and the like to be attached to the trailer. The tie downs may be part of the trailer, such as the hinges, or the tie downs may be separate structures that are attached to the trailer.

Yet another aspect is a trailer that may used to haul cargo such as a motorized vehicle. Advantageously, the motorized vehicle may then be used to tow the trailer. For example, a consumer could drive to a store in their automobile and purchase a trailer and a motorized vehicle such as a lawn tractor or all terrain vehicle (ATV) as a group or combination. The consumer could tow the trailer home with their automobile and the lawn tractor or ATV could be transported in the bed of the trailer. Significantly, the lawn tractor or ATV could then be unloaded from the trailer and the lawn tractor or ATV could be used to tow the trailer.

A further aspect is a trailer that may include a weight indicator that is sized and configured to indicate at least a portion of the load carried by the trailer. Desirably, the weight indicator includes a pointer connected to a suspension member. The suspension member may comprise a leaf spring and a first end of the leaf spring may be connected to a first portion of the frame and a second end of the leaf spring may be connected to a second portion of the frame. The trailer may also include a second weight indicator that is sized and configured to indicate at least a portion of the load carried by the trailer. Advantageously, the first and second weight indicators may be sized and configured to collectively indicate whether the trailer is loaded evenly.

A still further aspect is a method for using a trailer. The method may comprise: using a first set of one or more fasteners to secure a towing arm to a frame of a partially unassembled trailer; towing the partially unassembled trailer by the towing arm; and after towing the partially unassembled trailer by the towing arm, replacing at least one of the first set of one or more fasteners with a second set of one or more fasteners to secure the towing arm to the frame. The first set of one or more fasteners may be sized and configured to receive a portion of a cotter pin to secure the towing arm to the frame. In addition, before towing the partially unassembled trailer by the towing arm, at least one light of the partially unassembled trailer may be connected to a trailer light interface provided by a towing vehicle. Further, the towing arm may form at least a portion of a conduit for carrying electrical wiring.

Another further aspect is a method for using a trailer. The method may comprise: using a first set of one or more fasteners to secure a towing arm to a trailer, the first set of one or more fasteners being sized and configured to receive a portion of a cotter pin to secure the towing arm to the trailer; towing the trailer by the towing arm from a first location to a second location; and after towing the trailer by the towing arm, replacing at least one of the first set of one or more fasteners with a second set of one or more fasteners to secure the towing arm to the trailer.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a perspective view of an exemplary trailer, illustrating a front barrier, a rear barrier, a left barrier and a right barrier;

FIG. 2 is a perspective view of the trailer shown in FIG. 1, illustrating the rear barrier opened downwardly;

FIG. 3 is a perspective view of the trailer shown in FIG. 1, illustrating the rear barrier opened sideways;

FIG. 4 is a perspective view of a portion of the trailer shown in FIG. 1, illustrating the rear barrier or gate;

FIG. 5 is a perspective view of a portion of the gate shown in FIG. 5, illustrating an exemplary latch;

FIG. 6 is a perspective view of another portion of the gate shown in FIG. 5, illustrating another exemplary latch;

FIG. 7 is a perspective view of still another portion of the gate shown in FIG. 5, illustrating a portion of an exemplary hinge;

FIG. 8 is a perspective view of yet another portion of the gate shown in FIG. 5, illustrating still another exemplary latch;

FIG. 9 is a perspective view of a portion of the trailer shown in FIG. 1, illustrating a portion of the left barrier;

FIG. 10 is a perspective view of a portion of the trailer shown in FIG. 1, illustrating a portion of the right barrier;

FIG. 11 is a perspective view of a portion of the trailer shown in FIG. 1, illustrating another portion of the right barrier;

FIG. 12 is a perspective view of a portion of the trailer shown in FIG. 1, illustrating another portion of the left barrier;

FIG. 13 is a top, partially exploded view of the trailer shown in FIG. 1, illustrating an exemplary rear extension;

FIG. 14 is a side perspective view of the trailer shown in FIG. 13;

FIG. 15 is a perspective, exploded view of an exemplary front extension that may be used in connection with the trailer shown in FIG. 1;

FIG. 16 is a top view of the front extension shown in FIG. 15;

FIG. 17 is a bottom perspective view of the trailer shown in FIG. 1;

FIG. 18 is an enlarged bottom perspective view of a portion of the trailer shown in FIG. 17;

FIG. 19 is an exploded view of a portion of the trailer shown in FIG. 17, illustrating an exemplary arm and exemplary flanges that may be used to connect the towing arm to the trailer;

FIG. 20 is a perspective view of a portion of the trailer shown in FIG. 1, illustrating an exemplary weight indicator;

FIG. 21 is a perspective view of a portion of the weight indicator shown in FIG. 20;

FIG. 22 is an exploded view of a portion of the weight indicator shown in FIG. 20;

FIG. 23 is a perspective view of an exemplary tie down or anchor that may be used in connection with the trailer;

FIG. 24 is another perspective view of the tie down shown in FIG. 23;

FIG. 25 is a left side view of the tie down shown in FIG. 23;

FIG. 26 is a right side view of the tie down shown in FIG. 23;

FIG. 27 is a top view of the anchor shown in FIG. 23;

FIG. 28 is a bottom view of the anchor shown in FIG. 23;

FIG. 29 is a front view of the anchor shown in FIG. 23;

FIG. 30 is a rear view of the anchor shown in FIG. 23;

FIG. 31 is a perspective view of the trailer shown in FIG. 1, illustrating the trailer in an exemplary collapsed or shipping configuration;

FIG. 32 is a top view of the trailer shown in FIG. 31;

FIG. 33 is a bottom perspective view of the trailer shown in FIG. 31;

FIG. 34 is a bottom view of the trailer shown in FIG. 31;

FIG. 35 is a perspective view of a plurality of the trailers in the collapsed or shipping configuration, illustrating the trailers in a stacked configuration;

FIG. 36 is a perspective view of a portion of the trailer shown in FIG. 31, illustrating an exemplary connection of a towing arm;

FIG. 37 is an enlarged perspective view of a portion of trailer shown in FIG. 36;

FIG. 38 is an enlarged perspective view of another portion of trailer shown in FIG. 36;

FIG. 39 is an exploded view of the portion of the trailer shown in FIG. 36;

FIG. 40 is an enlarged exploded view of a portion of trailer shown in FIG. 39; and

FIG. 41 is an enlarged exploded view of another portion of trailer shown in FIG. 39.

### DETAILED DESCRIPTION OF PREFERRED EMBODIMENTS

The present invention is directed towards a trailer. The principles of the present invention, however, are not limited to trailers. It will be understood that, in light of the present disclosure, the trailer disclosed herein can be successfully used in connection with other types of storage and/or transportation systems.

Additionally, to assist in the description of the trailer, words such as top, bottom, front, rear, right and left may be used to describe the accompanying figures. These figures may be, but are not necessarily, drawn to scale. It will be appreciated that the trailer and various components can also be located in a variety of desired positions—including various angles, sideways and even upside down. In addition, the trailer and various components of the trailer may have other sizes, shapes, configurations and arrangements that those shown in the drawings. A detailed description of the trailer now follows.

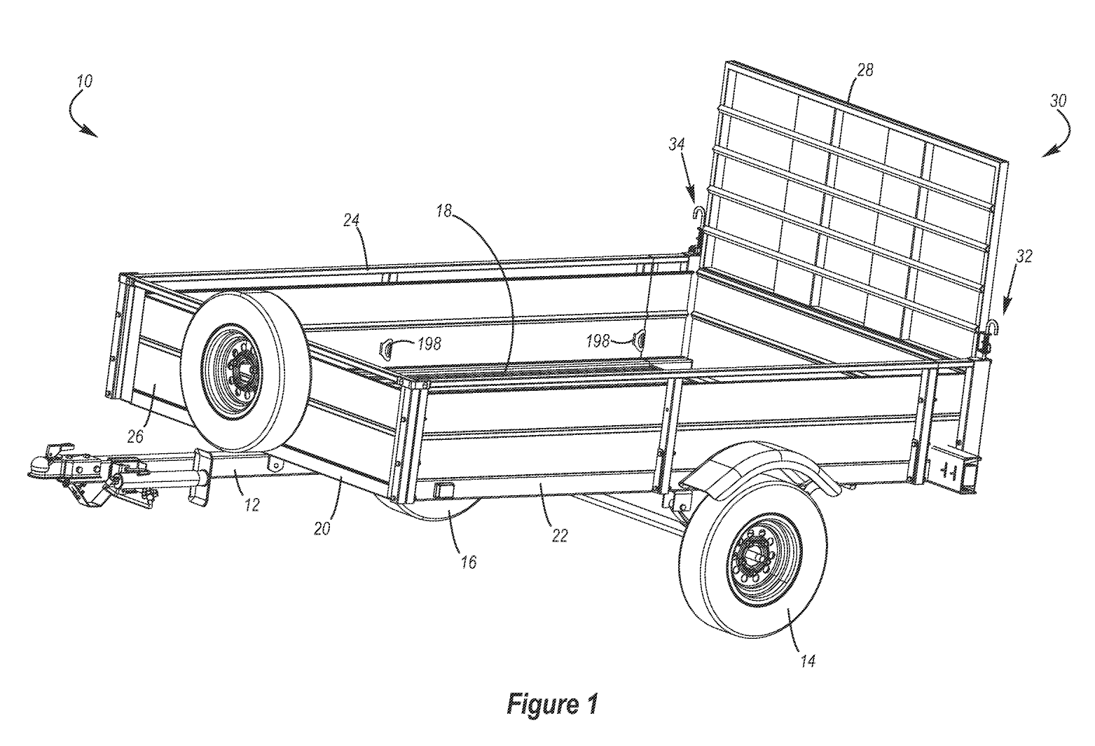

A trailer 10, such as shown in FIG. 1, may be used to store and/or transport various items. An automobile or other motorized vehicle may pull or otherwise move the trailer. Exemplary automobiles typically include, but are not limited to, a car, a truck and a sport utility vehicle (SUV). Other exemplary motorized vehicles include all-terrain vehicles (ATVs) and lawn tractors. Desirably, the trailer 10 may be easily moved and used for various suitable purposes such as camping, landscaping, traveling (such as to the beach or other recreational locations), moving items, and the like.

If desired, while being towed by a first vehicle, the trailer 10 may be used to carry a second vehicle, and the second vehicle may later be used to tow the trailer. For example, the second vehicle may comprise an all-terrain vehicle (ATV), a lawn tractor or the like, which may be sold with and loaded onto the trailer 10. By selling the trailer 10 and the second vehicle together, a store may experience greater sales for both items because the store may offer the items for sale at a discounted price when they are sold together. Moreover, using the trailer 10 to carry the second vehicle may provide some customers the means for transporting the second vehicle home, which may have been otherwise too difficult for the customers. For instance, a customer may purchase the trailer and when the customer arrives home, he or she may remove the lawn tractor from the trailer and use the lawn tractor to move the trailer. It will be appreciated that the lawn tractor and trailer may be purchased together, individually or in other combinations depending, for example, upon the intended use of the trailer 10.

The trailer 10 may include a towing arm 12 that may be sized and configured to be connected to a vehicle, which may pull the trailer. For example, the vehicle may include a hitch and the arm 12 may be sized and configured to be attached to the hitch. In particular, the arm 12 may include, or be connected to, a hitch coupler that may be sized and configured to couple the hitch of the vehicle. The hitch coupler may be sized and configured to be coupled to a variety of differently sized and/or configured hitches, if desired. It will be appreciated that the arm 12 of the trailer may be connected to a variety of other suitable vehicles, connectors and/or structures.

The trailer 10 may include one or more wheels 14, 16. The wheels 14, 16 may advantageously help the trailer 10 be pulled or otherwise moved. The wheels 14, 16 may have a variety of suitable shapes, sizes, configurations and arrangements. The trailer 10 may also include any suitable number of wheels. For example, the trailer 10 may have four wheels to enable the trailer, for example, to carry heavier loads.

As shown in FIG. 1, the trailer 10 may include a bed or floor 18 upon which one or more items carried by the trailer may rest. The trailer may include a frame 20 that may help support and/or strengthen the bed 18. It will be appreciated that the trailer 10 does not require the bed 18 and that one or more items may, for example, rest upon the frame 20 as the trailer carries those items.

The bed 18 may consist of a single component or a plurality of components. For example, the bed 18 may include two or more sections that interlock and/or overlap. The bed 18 may also have a corrugated configuration. Advantageously, the corrugated portions may interlock and/or overlap to help create a stronger and/or more rigid bed 18 for the trailer 10. In addition, if the bed 18 is constructed from multiple sections, the may help disperse impacts and forces applied to the bed, which may help prevent damage to the bed. Further, if the bed 18 includes overlapping and/or interlocking portions, that may help reinforce and strengthen the bed. If desired, the bed 18 may be provided with a coating or layer that covers, for example, the upper surface of the bed. The coating may help interconnect the various portions of the bed 18 and prevent damage to the trailer 10. The bed 18 is preferably constructed from metal, such as steel, but it may be constructed from other materials with appropriate characteristics and properties. It will be appreciated that the bed 18 may have a variety of different shapes, sizes, arrangements and configurations depending, for example, upon the intended use of the trailer 10. For example, other suitable beds and trailers may be shown in U.S. patent application Ser. No. ______, entitled TRAILER, which was filed Dec. 11, 2006, (Attorney Docket No. 15499.807.4), the disclosure of which is incorporated by reference in its entirety.

The trailer 10 may include one or more walls or barriers, which may help maintain items within the trailer. For example, as shown in the accompanying figures, the trailer 10 may include a left side barrier 22, a right side barrier 24, a front barrier 26 and a rear barrier 28. These barriers 22, 24, 26, 28 may be connected to, or form part of, the bed 18 and/or the frame 20. As discussed in greater detail below, the barriers 22, 24, 26, 28 are preferably connected to the frame 20 by fasteners, but the barriers may be connected to the trailer 10 by other suitable structures or means.

In further detail, as shown in FIG. 1, the barriers 22, 24, 26, 28 may have a generally fence-shaped configuration including at least one generally horizontal railing and/or at least one generally vertical support or post. The barriers 22, 24, 26, 28 may also include a covering, such as a sheet of material. In particular, the barriers 22, 24, 26, 28 could include a covering constructed from sheet metal or galvanized steel. Additionally, the covering could be constructed from one or more sections and these sections preferably overlap and/or interlock. These overlapping and/or interlocking portions may help interconnect and/or position the coverings. For example, the overlapping and/or interlocking portions may have a corrugated shape or configuration and the overlapping and/or interlocking portions may help increase the strength and/or rigidity of the barriers 22, 24, 26, 28. It will be appreciated that the barriers 22, 24, 26, 28 could have other suitable sizes, shapes, configurations, arrangements and the like depending, for example, upon the intended use of the trailer 10.

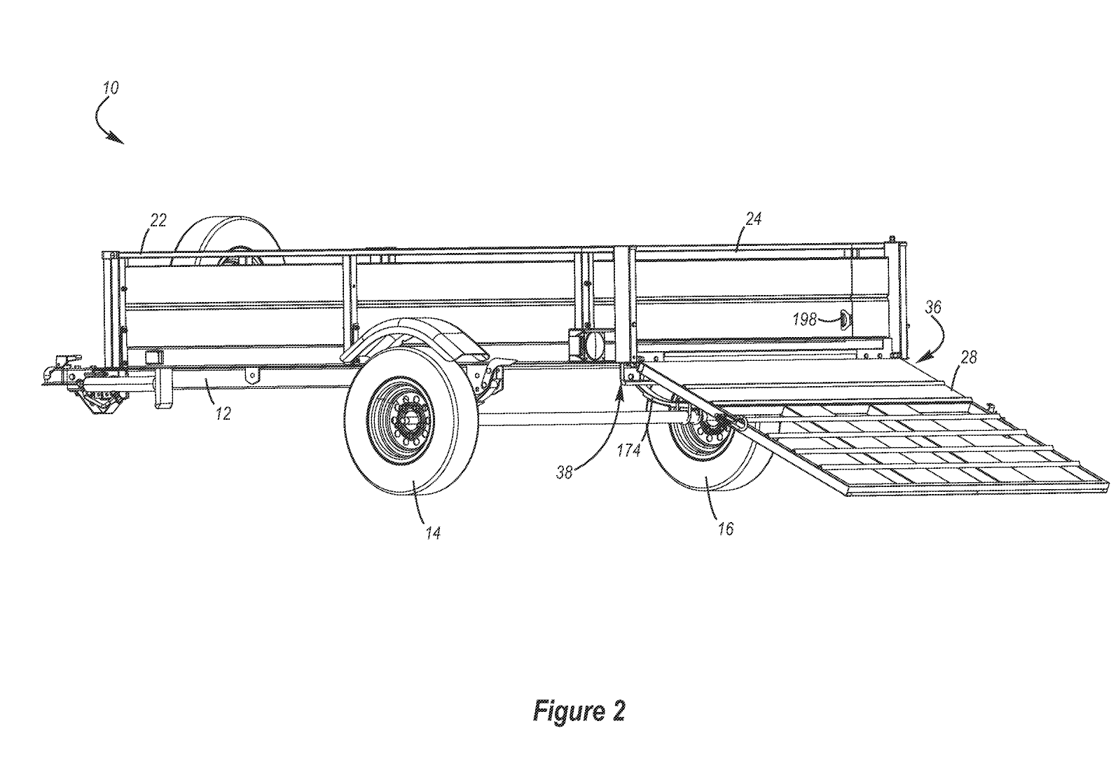

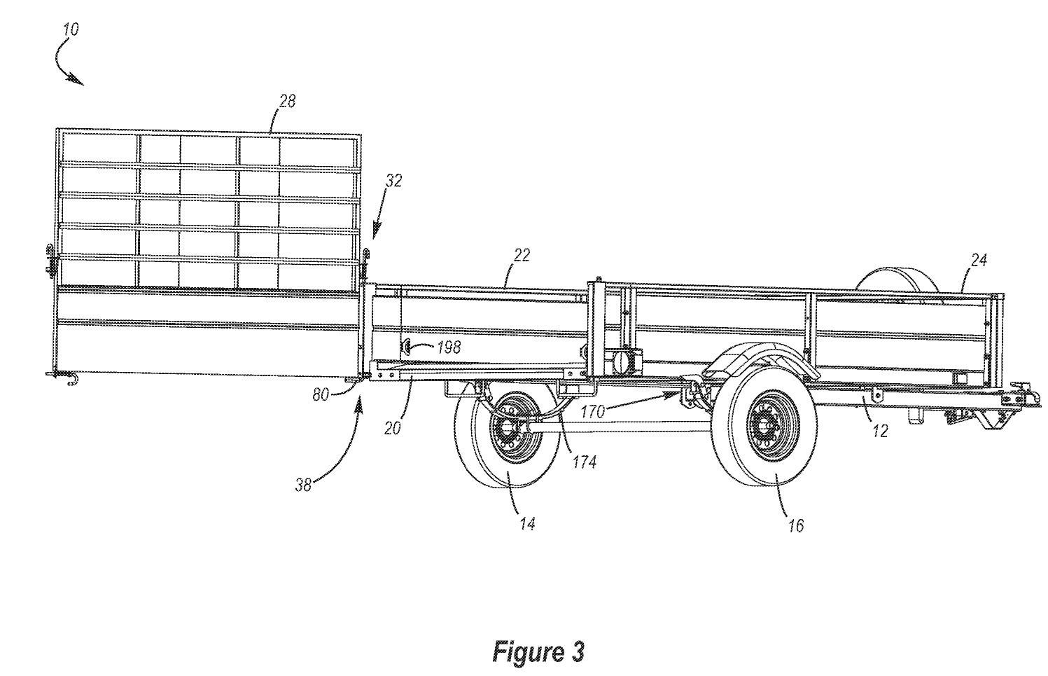

Advantageously, the barriers 22, 24, 26, 28 may be moveably connected to the trailer 10. For example, the front barrier 26 may pivot or move forwardly or downwardly to allow for longer items (such as large pieces of plywood or drywall) to extend past the front edge of the bed 18. The rear barrier 28 may pivot or move downwardly and/or rearwardly to allow longer items to be transported by the trailer 10 and this may allow the rear barrier to be used as a ramp to the trailer bed 18, as shown in FIG. 2. Preferably, the rear barrier 28 may also move or pivot sideways relative to the trailer as shown in FIG. 3. Thus, the barrier 28 may be pivoted downwardly and/or rearwardly to provide a ramp for easy access to the trailer 10. The rear barrier 28 may also be pivoted to the side when access with a ramp is not desired to allow easy access to the trailer 10.

The trailer 10 preferably includes a gate mechanism 30 that allows the rear barrier 28 to move downwardly and sideways. As discussed in greater detail below, the gate mechanism 30 may also allow the rear barrier 28 to be quickly and easily removed. Thus, the gate mechanism 30 may allow a three-way gate to be created. It will be appreciated, however, that the trailer 10 may include any suitable type of barriers 22, 24, 26, 28 and gate mechanism 30 depending, for example, upon the intended use of the trailer 10. Further, the trailer 10 does not require either the barriers 22, 24, 26, 28 or the gate mechanism 30.

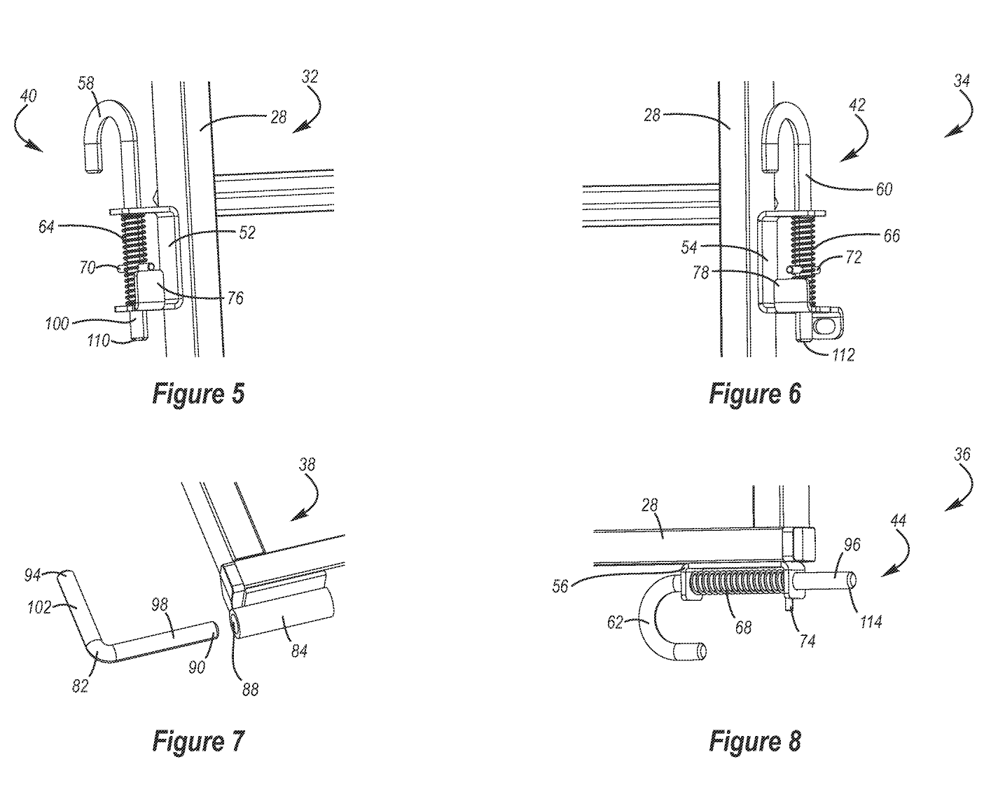

In greater detail, the gate mechanism 30 may include various latching engagement and release mechanisms that are connected to the rear barrier 28 and/or other portions of the trailer 10. In particular, as shown in FIGS. 1-3, the gate mechanism 30 may include a first mechanism 32, a second mechanism 34, a third mechanism 36 and a fourth mechanism 38. As best seen in FIGS. 5-8, the mechanisms 32, 34, 36 may include a latch 40, 42, 44, respectively, that is sized and configured to move between a locked position and an unlocked position. When in the locked position, the latches 40, 42, 44 may engage various portions of the trailer 10 to prevent the rear barrier 28 from undesirably moving. When one or more of the latches 40, 42, 44 are disengaged and in the unlocked position, then the rear barrier 28 may be movable relative to the trailer 10. For example, in the locked position, the latches 40, 42, 44 may respectively engage openings 46, 48, 50 formed in the left barrier 22 and the right barrier 24. The latches 40, 42, 44 may be mounted to the trailer 10 using brackets 52, 54, 56, respectively.

As best seen in FIGS. 5, 6 and 8, the latches 40, 42, 44 may include a pin 58, 60, 62 and the latches are preferably biased into a desired position a biasing member, such as a spring 64, 66, 68, respectively. The pins 58, 60, 62 may be moved between locked and unlocked positions, and the springs 64, 66, 68 preferably bias the pins into the locked position. For example, the springs 64, 66, 68 may exert a force against the pins 58, 60, 62 to bias the pins into the locked position.

The pins 58, 60, 62 may include retaining members 70, 72, 74, respectively, that are sized and configured to selectively retain the pin in an unlocked position. In particular, the retaining members 70, 72, 74 may be positioned to engage a portion of the trailer 10 when the pin 58, 60, 62 are in an unlocked position to retain the pins in the unlocked position. For example, a portion of the pins 58, 60 may engage a portion 76, 78 of the brackets to retain the pins in the unlocked position.

As shown in FIGS. 2, 4, 7 and 11, the mechanism 38 may include hinge 80. The hinge 80 may include a pin 82, a first member 84 that is sized and configured to receive a first portion of the pin, and a second member 86 that is sized and configured to receive a second portion of the pin. The pin 82 preferably has a generally L-shaped configuration. In addition, the first member 84 may include a receiving portion 88 that is sized and configured to receive a first end 90 of the pin 82, and the second member 86 may include a receiving portion 92 that is sized and configured to receive a second end 94 of the pin 82. The first and second members 84, 86 preferably have a tubular configuration and are preferably connected to the barriers 28, 22 respectively. It will be appreciated that the pin 82, the first and second members 84, 86, and the mechanism 38 may have other suitable shapes, sizes, arrangements and configurations depending, for example, upon the size and shape of the trailer 10. In addition, the mechanism 38, the pin 82, and the first and second members 84, 86 may be connected to other portions of the trailer 10.

The gate mechanism 30 may be sized and configured to allow the rear barrier 28 to pivot or move downwardly and/or rearwardly to provide a ramp for accessing the trailer 10, as shown in FIG. 2. In particular, with the gate mechanism 30 in the closed position as shown in FIG. 1, the latches 40, 42 may be moved from the locked position to the unlocked position by moving the pins 58, 60 from the locked position to the unlocked position. With the latches 40, 42 in the unlocked position and with the latch 44 in a locked position, the rear barrier 28 may be moved downwardly and/or rearwardly to create the ramp by pivoting about the latch 44 and the hinge 80. In particular, a generally horizontal portion 96 of the pin 62 of the latch 44 may be generally aligned with a generally horizontal portion 98 of the pin 82 of the hinge 80, which may help the rear barrier 28 pivot downwardly and/or rearwardly.

The gate mechanism 30 may also be sized and configured to allow the rear barrier 28 to pivot or move sideways, as shown in FIG. 3. In particular, with the gate mechanism 30 in the closed position shown in FIG. 1, the latches 42, 44 may be moved from the locked position to the unlocked position by, for example, moving the pins 60, 62 from the locked position to the unlocked position. With the latches 42, 44 in the unlocked position and with the latch 40 in a locked position, the rear barrier 28 may be moved sideways by pivoting about the latch 40 and the hinge 80. In particular, a generally vertical portion 100 of the pin 58 of the latch 40 may be generally aligned with a generally vertical portion 102 of the pin 82 of the hinge 80, which may help the rear barrier 28 pivot sideways. Thus, as shown above, the hinge 80 desirably may comprise a multi-directional hinge that helps the rear barrier 28 to pivot or otherwise move in multiple directions. In particular, the generally horizontal portion 98 of the pin 82 of the hinge 80 helps the rear barrier 28 pivot downwardly and/or rearwardly, and the generally vertical portion 102 of the pin 82 helps the rear barrier 28 pivot sideways.

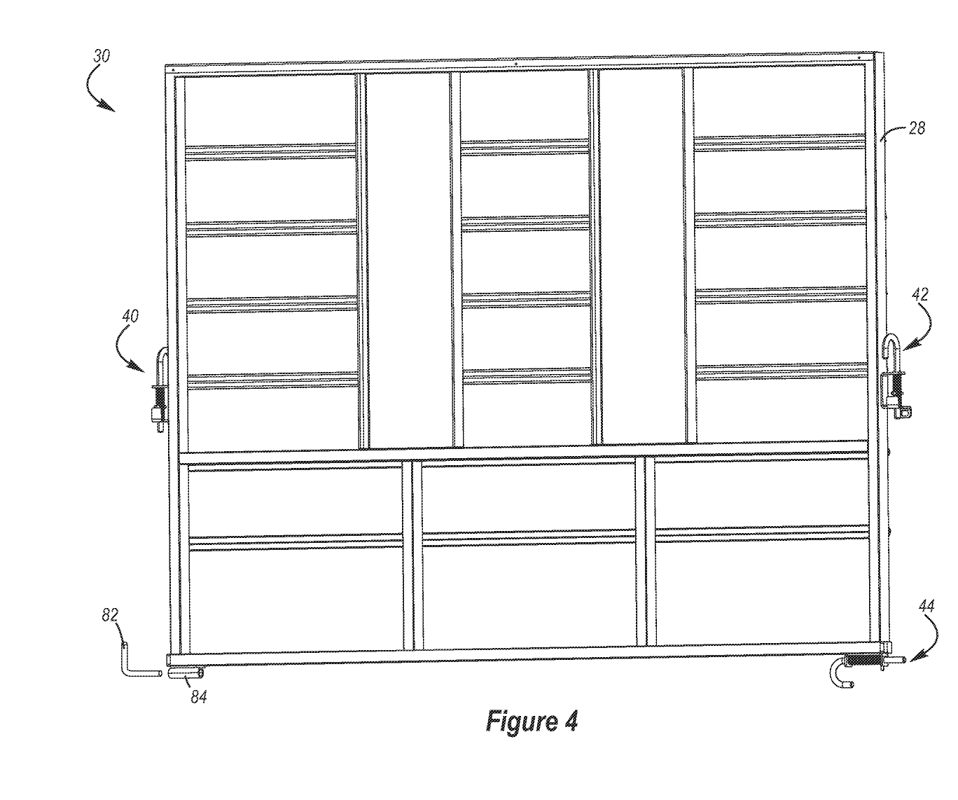

As shown in FIG. 4, the latch 40 may be spaced apart from the top and/or the bottom of the barrier 28. For example, the latch 40 is preferably disposed proximate a central portion of a side of the barrier 28, which may advantageously help the latch 40 and the hinge 80 to more efficiently support the barrier's weight when the barrier is moved sideways. In particular, this position may allow the latch 40 and hinge 80 each to support about half of the weight of the barrier 28. It will be appreciated, however, that the latch 40 may be disposed in other suitable locations and that the latch 40 and/or the hinge 80 may support any particular amount of the weight of the barrier 28.

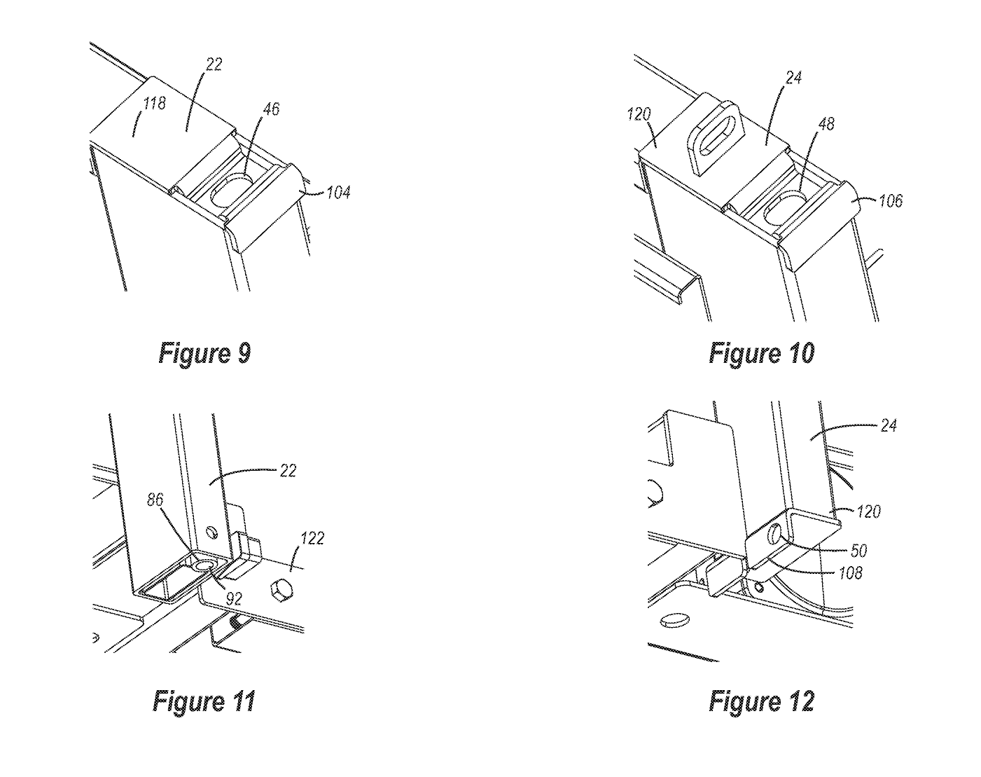

Preferably, the gate mechanism 30 automatically retains the rear barrier 28 in a generally fixed position when the rear barrier is returned to the closed position shown in FIG. 1. In particular, as shown in FIGS. 9-10, the barriers 22, 24 may include guide members 104, 106, 108 that help the gate mechanism 30 automatically retain the rear barrier 28 in the closed position.

In further detail, as the rear barrier 28 is moved from the open position shown in FIG. 2 to the closed position shown in FIG. 1, the pins 58, 60 may contact the guide members 104, 106. In particular, the ends 110, 112 of the pins 58, 60 may slide along and/or against a portion of the guide members 104, 106. To help the ends 110, 112 of the pins 58, 60 slide along and/or against the guide members 104, 106, the ends 110, 112 and/or the guide members 104, 106 may have generally smooth and/or curved surfaces. As the pins 58, 60 contact the guide members 104, 106, the guide members may help compress the springs 64, 66. When the pins 58, 60 reach the openings 46, 48, the springs 64, 66 may bias the pins into the openings to automatically retain the barrier 28 in the closed position.

Similarly, as the rear barrier 28 is moved from the open position shown in FIG. 3 to the closed position shown in FIG. 1, the pins 60, 62 may contact the guide members 106, 108. In particular, the ends 112, 114 of the pins 60, 62 may slide along and/or against a portion of the guide members 106, 108. To help the ends 112, 114 of the pins 60, 62 slide along and/or against a portion of the guide members 104, 106, the ends 112, 114 and/or the guide members 106, 108 may have generally smooth and/or curved surfaces. As the pins 60, 62 contact the guide members 106, 108, the guide members may help compress the springs 66, 68. When the pins 60, 62 reach the openings 48, 50, the springs 66, 68 may bias the pins into the openings to automatically retain the barrier 28 in the closed position.

If desired, the gate mechanism 30 may also be sized and configured to retain or automatically retain the rear barrier 28 in other generally fixed positions. For example, it may be desired to retain the rear barrier 28 in the open positions shown in FIGS. 2-3. It will be appreciated, however, that the gate mechanism 30 need not automatically retain the rear barrier 28 in the open positions, closed position or any other position.

The barriers 22, 24, 26, 28 may also be selectively removed or detached from the trailer 10. For example, the gate mechanism 30 may be sized and configured to allow the rear barrier 28 to be removed. In particular, with the gate mechanism 30 in the closed position shown in FIG. 1, the latches 40, 42 may be moved from the locked position to the unlocked position by moving the pins 58, 60 from the locked position to the unlocked position. With the latches 40, 42 in the unlocked position and with the latch 44 in a locked position, the rear barrier 28 may be moved downwardly and/or rearwardly. Next, the latch 44 may be moved from the locked position to the unlocked position by moving the pin 62 from a locked position to an unlocked position. With the latch 44 in the unlocked position, the barrier 28 may be moved so that the pin 82 of the hinge 80 is removed from the receiving portion 88 of the member 84 of the hinge, thus allowing the barrier 28 to be disconnected from the trailer 10.

Similarly, with the gate mechanism 30 in the closed position shown in FIG. 1, the latches 42, 44 may be moved from the locked position to the unlocked position by moving the pins 60, 62 from the locked position to the unlocked position. With the latches 42, 44 in the unlocked position and with the latch 40 in a locked position, the rear barrier 28 may be moved sideways. Next, the latch 40 may be moved from the locked position to the unlocked position by moving the pin 58 from the locked position to the unlocked position. With the latch 40 in the unlocked position, the barrier 28 may be moved so that the pin 82 of the hinge 80 may be removed from the receiving portion 92 of the member 88 of the hinge. This allows the barrier 28 to be disconnected from the trailer 10.

As discussed above, the gate mechanism 30 may allow the rear barrier or gate 28 to be easily opened and closed. The gate mechanism 30 may also create a three-way gate in which the rear barrier 28 can be moved vertically, horizontally or detached. Advantageously, the gate mechanism 30 allows the gate 28 to be moved and removed from the trailer 10 without tools and without connecting or disconnecting any bolts, nuts, screws and the like. Thus, the rear barrier 28 and the gate mechanism 30 may be simpler, easier and faster than conventional gates.

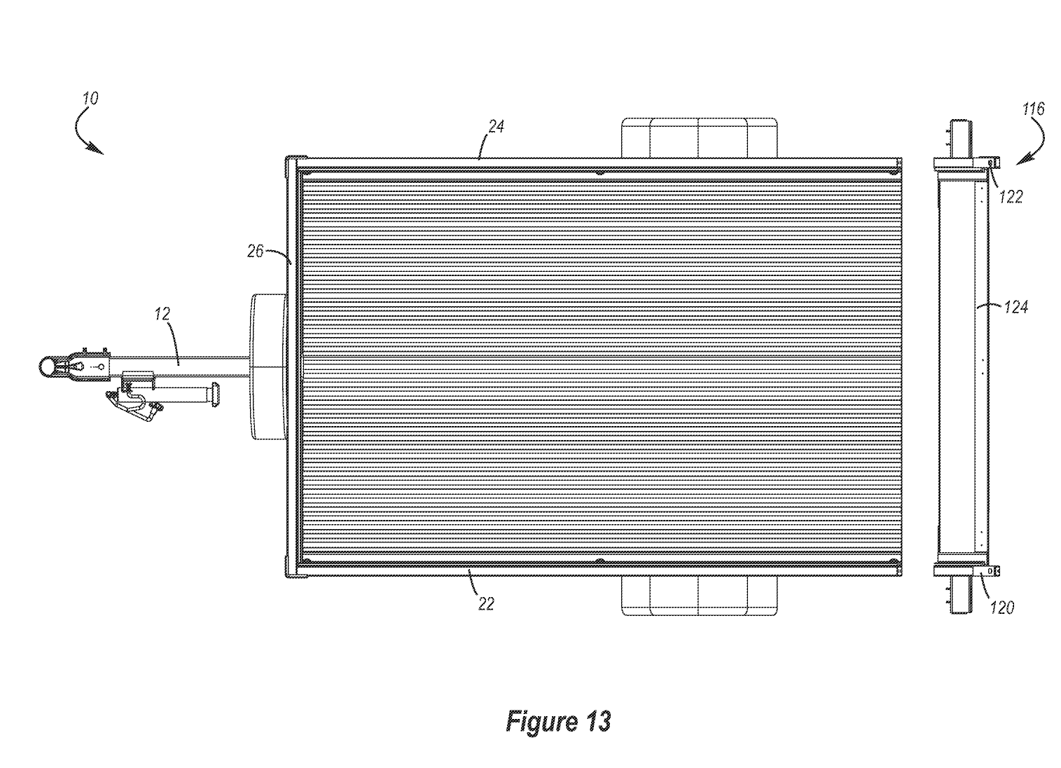

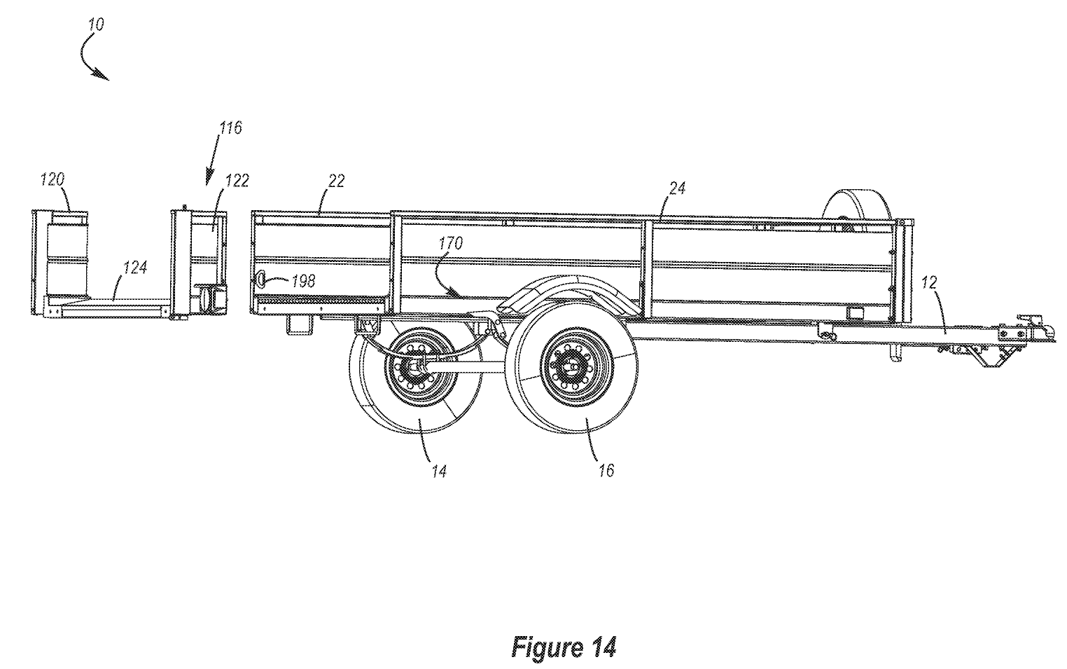

The trailer 10 may include an extension, which may be selectively connected to and disconnected from the trailer. The extension may help increase the trailer's capacity to carry items. For example, as shown in FIGS. 13-14, the trailer 10 may include a rear extension 116, which may be attached to the rear portion of the trailer and may be used to increase the capacity of the bed 18. As discussed in more detail below, the extension 116 may allow longer items to be disposed within the trailer 10. The trailer 10 may also be used without the extension 118, which may items to extend beyond the rear edge of the bed 18.

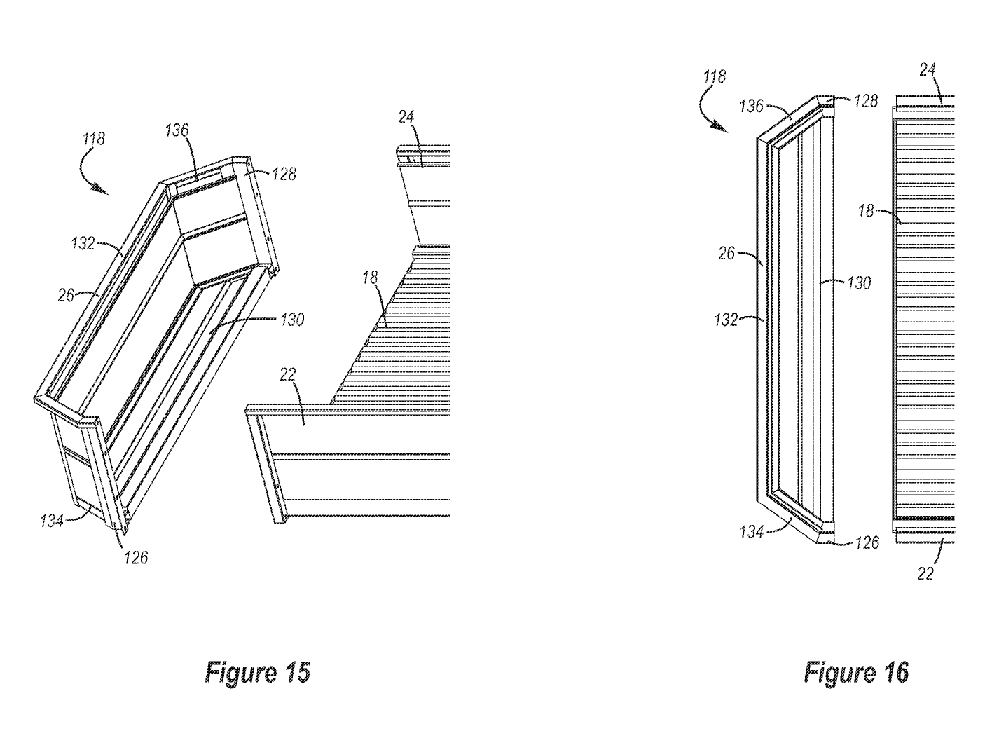

As best seen in FIGS. 15 and 16, the trailer 10 may include a front extension 118 that is attached to the front portion of the trailer. The front extension 118 may also be used to increase the capacity of the bed 18 and allow longer items to be disposed within the bed. The trailer 10 could also be used without the extension 118 to allow items to extend beyond the front edge of the bed 18.

In greater detail, the extensions 116, 118 may have a length of about 6-10 inches (15-25 centimeters), which may increase the length of the bed 18 from about 90 inches (2.3 meters) to about 96-100 inches (2.4-2.5 meters). Desirably, this may allow the bed 18 to accommodate sheets of plywood or drywall having a length of eight feet or 96 inches (2.4 meters). The extensions 116, 118 may also allow the trailer 10 to be shipped in conventional or standard-sized shipping containers because the trailer may be shipped without the extension connected. For example, the trailer 10 may advantageously be arranged in a shipping configuration that is less than about 92 inches in length. It will be appreciated that the extensions 116, 118 may be larger or smaller depending upon, for example, the particular configuration of the trailer 10. It will also be appreciated that the trailer 10 may include any suitable number of extensions, such as an extension at the front of the trailer and another extension at the rear of the trailer. Further, it will be appreciated that the trailer 10 may include extensions in any suitable locations, such as along the sides of the trailer.

The front and rear extensions 116, 118 may include a variety of components. For example, as shown in FIGS. 13-14, the rear extension 116 may include a first portion 120 that may be connected to or form a part of the left barrier 22, a second portion 122 that may be connected to or form a part of the right barrier 24, and a third portion 124 that may be connected to or form a part of the bed 18 and/or the frame 20. Consequently, as shown in FIGS. 1 and 5-12, the rear barrier 28 may be connected to the portions 120, 122, 124 of the rear extension 116, if desired. As shown in FIGS. 15-16, the front extension 118 may include a first portion 126 that may be connected to or form a part of the left barrier 22, a second portion 128 that may be connected to or form a part of the right barrier 24, a third portion 130 that may be connected to or form a part of the bed 18 and/or the frame 20, and a fourth portion 132 that may be connected to or form a part of the front barrier 26. The front extension 118 may also include tapered portions 134, 136 that taper toward the sides of the trailer 10. Advantageously, the tapered portions 134, 136 may help prevent the trailer 10 from unintentionally colliding with a vehicle pulling the trailer. In particular, the tapered portions 134, 136 may increase the distance between the trailer 10 and the vehicle as the vehicle is turning, which may allow a greater turning radius. It will be appreciated that the trailer 10 and tapered portions 134, 136 may have a variety of sizes and shapes which may provide, for example, a greater turning radius

The front and rear extensions 116, 118 may be pivotally or movably attached to the trailer 10 using, for example, one or more hinges. This may allow the front and rear extensions 116, 118 to be pivoted or moved between various positions. It will be appreciated that the front and rear extensions 116, 118 need not be pivotally or movably connected to the trailer 10. For example, the extensions 116, 118 could be permanently securely attached to the trailer 10 so that the extensions 116, 118 are held in a fixed position. It will also be appreciated that the extensions 116, 118 could be attached to the trailer using other suitable connectors such as fasteners, adhesives, welding and the like. Further, the trailer 10 does not require the use of either the front or rear extensions 116, 118.

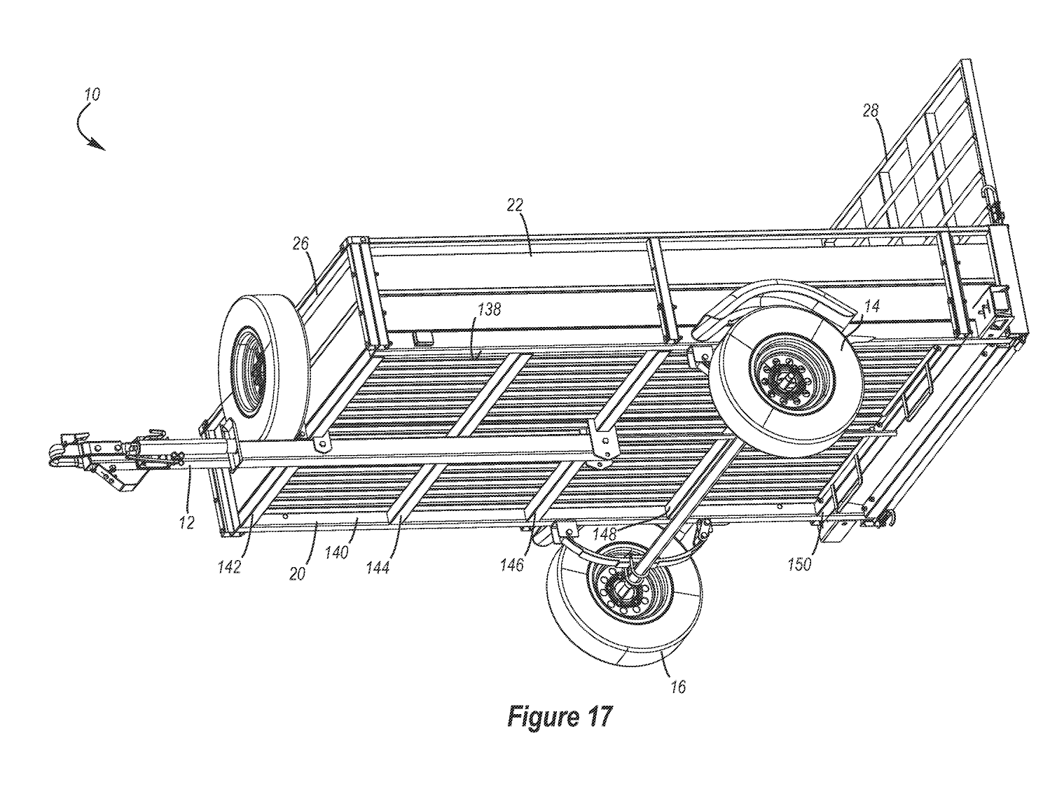

As shown in FIGS. 17-19, the frame 20 may include elongated supports 138, 140, 142, 144, 146, 148, 150. The supports 138, 140 preferably extend longitudinally along the length of trailer 10 between the trailer's front and rear; and the supports 142, 144, 146, 148, 150 preferably extend laterally along the width of the trailer between the trailer's left and right sides. The supports 138, 140, 142, 144, 146, 148, 150 are preferably constructed from a strong and rigid material, such as steel, and the supports are preferably securely connected by fasteners, welding, adhesives and the like. It will be appreciated that the frame 20 may include any suitable number of supports and the supports arranged in a variety of other suitable configurations and arrangements depending, for example, upon the size and shape of the trailer 10.

As best seen in FIG. 17, the arm 12 of the trailer 10 may be connected to the frame 20. For example, the arm 12 may be connected to the support members 142, 146 using flanges 152, 154. In further detail, the flange 152 may have a generally U-shaped configuration with a channel 156 that is sized and configured to receive a portion of the arm 12. When the arm 12 is inserted into the channel 156 of the flange 152, the arm may be connected to the frame 20. Likewise, the flange 154 may have a generally U-shaped configuration with a channel 158 that is sized and configured to receive a portion of the arm 12. The arm 12 may be connected to the frame 20 when the arm 12 is inserted into the channel 158 of the flange 154.

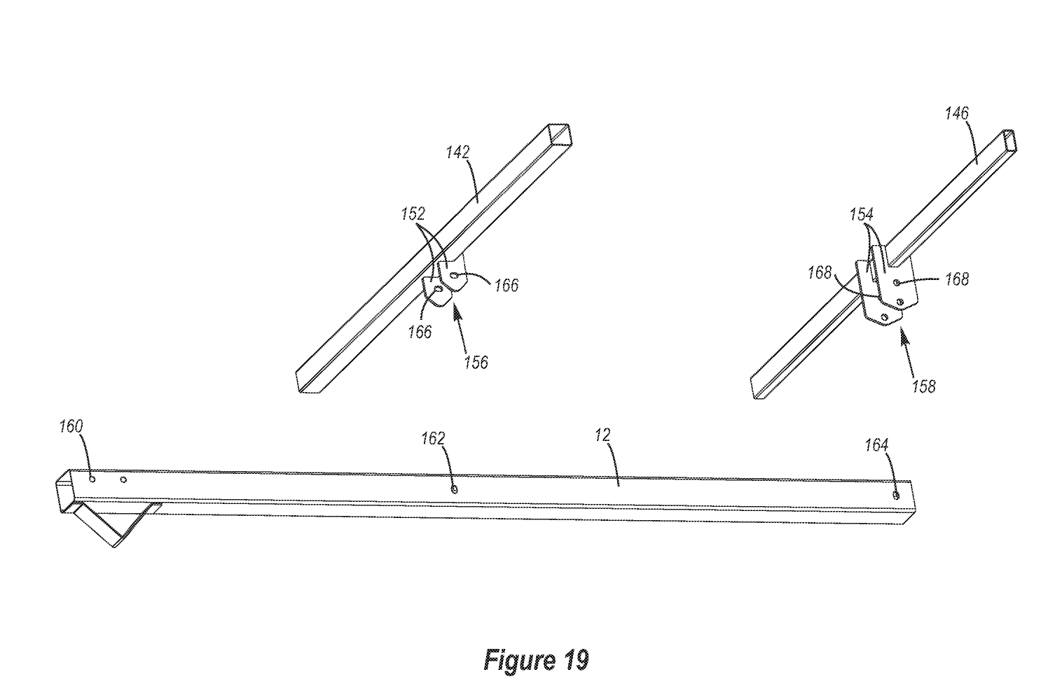

Desirably, the arm 12 may be connected to the frame 20 in a plurality of different positions. In particular, the arm 12 may be connected to the flanges 152, 154 in a use or extended position and a storage or retracted position. For example, the arm 12 and the flanges 152, 154 may include openings that are sized and configured to receive fasteners or pins to connect the arm to the support members 142, 146 in the use or extended position and the storage or retracted position. For example, as best seen in FIG. 19, the arm 12 may include openings 160, 162, 164 that extend through the arm and the flanges 152, 154 may include generally aligned openings 166, 168, respectively. To connect the arm 12 to the frame 20 in the retracted or storage position, the opening 160 in the arm 12 may be aligned with the openings 166 in the flange 152 to receive a first pin or fastener. In addition, the opening 162 in the arm 12 may be aligned with the openings 168 in the flange 154 to receive a second pin or fastener. Desirably, this may allow the arm 12 mounted to the trailer 10 and stored underneath the bed 18 and/or the frame 20. Thus, the arm 12 may be substantially or completely stored underneath the bed 18 and/or frame 20.

To connect the arm 12 to the frame 20 in the extended or use position, the pins or fasteners may be removed from the openings 160, 162 in the arm 12 and the openings 166, 168 in the flanges 152, 154. This may allow the arm 12 to slide or move within the channels 156, 158 to a new position in which the openings 162, 164 in the arm are aligned with the openings 166, 168 in the flanges 152, 154, respectively. A first pin or fastener may be inserted through the generally aligned openings 162 in the arm 12 and the openings 166 in the flange 152 to connect the arm to the frame 20. A second pin or fastener may be inserted through the generally aligned openings 164 in the arm 12 and the openings 168 in the flange 154 to connect the arm to the frame 20.

Advantageously, the arm 12 may be quickly and easily moved between the use and storage positions. In addition, the arm 12 may be quickly and easily attached and detached from the frame 20. This may allow, for example, the trailer 10 to be quickly and easily moved between the storage and use positions. This may also allow a store to sell the trailer 10 in the collapsed position and the user may quickly and easily use the trailer. For example, the arm 12 may be connected to the frame 20 by fasteners such as cotter pins and when the consumer purchases the trailer 10, they may simply remove the cotter pins to move the arm 12 from the collapsed position to the use position and secure the arm in the use position with the cotter pins. Significantly, this may allow the trailer 10 to be moved from the store without tools. Once the trailer 10 is moved from the store, then the arm 12 may be attached frame using fasteners such as bolts. It will be appreciated that the arm 12 may be connected to the frame 20 using other suitable types of fasteners, adhesives, welding and the like depending, for example, upon the intended use of the trailer 10. It will also be appreciated that the arm 12 could be attached to other suitable portions of the trailer 10, such as the bed 12.

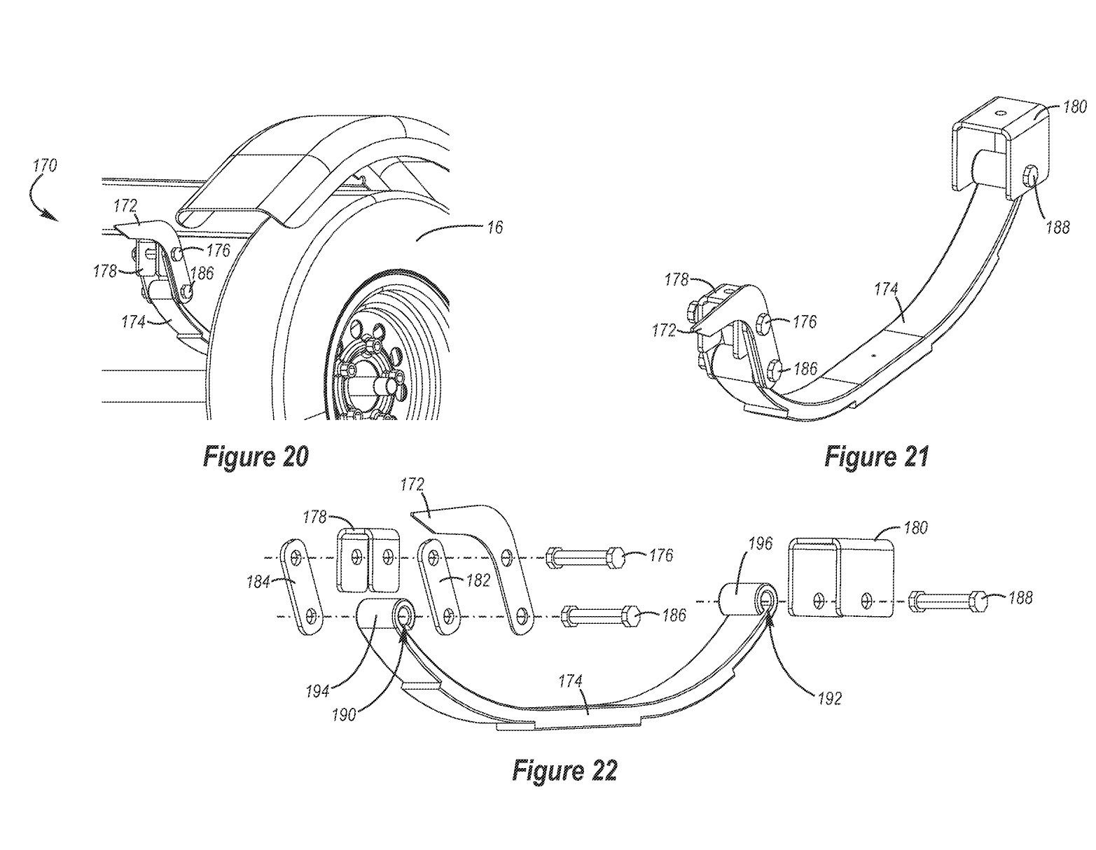

As shown in FIGS. 20-22, the trailer 10 may include a weight indicator 170, which may be configured to indicate the weight of the trailer and whether the trailer's load exceeds a particular amount of weight. In particular, the weight indicator 170 may include a pointer 172 and the position of the pointer may advantageously indicate the trailer's load. For example, as the trailer's load changes, the pointer 172 may point to different portions of a legend that are sized and configured to indicate whether the trailer's load exceeds the trailer's capacity, how much of the trailer's capacity is available, how much of the trailer's capacity is being used, and/or the like. The legend may comprise, for example, a decal that is placed onto a portion of the trailer. The legend may be painted, etched, molded or otherwise positioned on a desired portion of trailer.

Advantageously, the weight indicator 170 may also quickly and easily indicate how much weight it placed in the trailer 10. For example, as the weight of items in the trailer 10 increases, the suspension system that must support the weight may also change. For example, if the trailer 10 includes a leaf spring type suspension system and the pointer 172 is attached to the leaf spring, then the leaf spring will bend as different amounts of weight are placed on the trailer. Because the pointer 172 may indicate how much the leaf spring has moved, that may be used to indicate how much weight is disposed in the trailer 10. Significantly, the load indicator 170 may have very few parts and it may be quickly and easily attached to the trailer 10. It will be appreciated that the weight indicator 170 may have other suitable configurations and arrangements, and it may be attached to different portions of the trailer.

In greater detail, as shown in FIGS. 2-3, 18 and 20-22, the trailer 10 may include a suspension system 174 and the pointer 172 may be coupled to the suspension system. As items are placed in the trailer 10, the increased load may cause the suspension 174 to move or deflect, and that may cause the pointer 172 to pivot about a fastener 176. As items are removed from the trailer 10, the decreased load may cause the suspension 174 to return towards its original position and that may cause the end of the pointer 172 to move in an opposite direction. Because the end of the pointer 172 may move upward and downward, it may point to different portions of the legend to indicate the amount of load in the trailer 10.

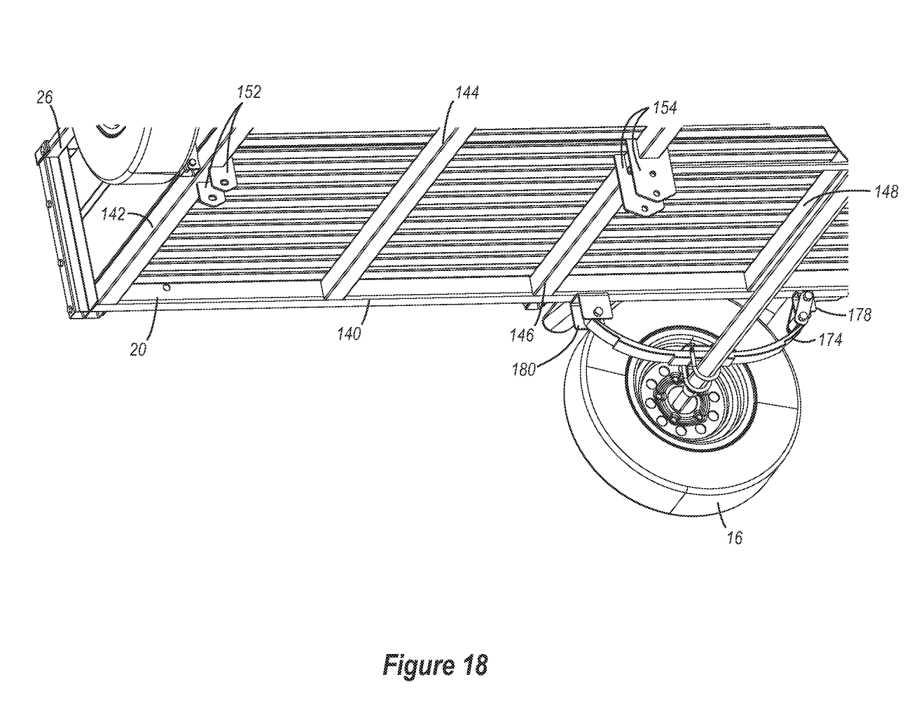

As shown in FIGS. 18 and 20-22, the pointer 172 and the suspension system 174 may be connected to the frame 20 using brackets 178, 180. The brackets 178, 180 are preferably connected to the support member 140 of the frame 20 in a fixed position, and the pointer 172 and the suspension system 174 are preferably pivotally or movably connected to the brackets. For example, the suspension system 174, which may consist of a leaf spring, may be pivotally connected to the bracket 178 using links 182, 184 and fasteners 176, 186; and the suspension may be pivotally connected to the bracket 180 using a fastener 188. The pointer 172 may be pivotally connected to the bracket 178 and the suspension system 174 by the fasteners 176, 186. As shown in FIG. 22, the pointer 172, the brackets 178, 180, the links 182, 184 and the suspension member 174 may include openings or receiving portions that are sized and configured to receive the fasteners 176, 186, 188 to facilitate these connections. In particular, the suspension member 174 may include receiving portions 190, 192 that are sized and configured to receive the fasteners 186, 188, respectively. The receiving portions 190, 192 are preferably formed by bending the end portions 194, 196 of the leaf spring or suspension member of the suspension system 174.

As best seen in FIG. 22, the links 182, 184 preferably have a generally flat configuration. The links 182, 184 may, however, have other suitable shapes and configurations. For example, the links 182, 184 may have a generally U-shaped configuration with the ends of the “U” abutting against and/or extending towards opposing sides of the suspension member 174. Also, additional such U-shaped links may have their ends abutting against and/or extending towards other portions of the suspension system 174. To assist in connecting the suspension 174 to the frame 20 of the trailer 10, a first pair of such U-shaped links may be position proximate a first end of the suspension member and a second pair of such U-shaped links may be position proximate a second end of the suspension member. It will be appreciated that the suspension system 174 may be attached to the trailer 10 using other suitable structures and devices.

As shown in FIGS. 2-3, 18 and 20-22, the suspension system 174 preferably includes a leaf spring and the leaf spring may include several layers of leaves, if desired. The leaf spring may also have variations in thickness and shape, for example, depending upon the intended use of the trailer. Advantageously, the leaf spring may spread the load more widely over the frame 20 and the leaf spring may provide an improved ride quality. It will be appreciated that any suitable type of suspension system 174 could be used and the suspension system may have other suitable shapes, sizes, configurations and arrangements.

The trailer 10 may also include multiple weight indicators 170. For example, the trailer 10 may include a first weight indicator 170 including a first pointer 172 coupled to a first suspension member 174 and a second weight indicator including a second pointer coupled to a second suspension member. Desirably, the weight indicated by the weight indicators 170 may be compared with each other to determine whether the trailer 10 is loaded unevenly. In particular, when a first weight indicator 170 positioned proximate a first side of the trailer 10 shows a greater load than a second weight indicator positioned proximate a second side of the trailer, the trailer may undesirably be loaded unevenly. Consequently, the items carried by the trailer 10 may be repositioned to more evenly balance the load.

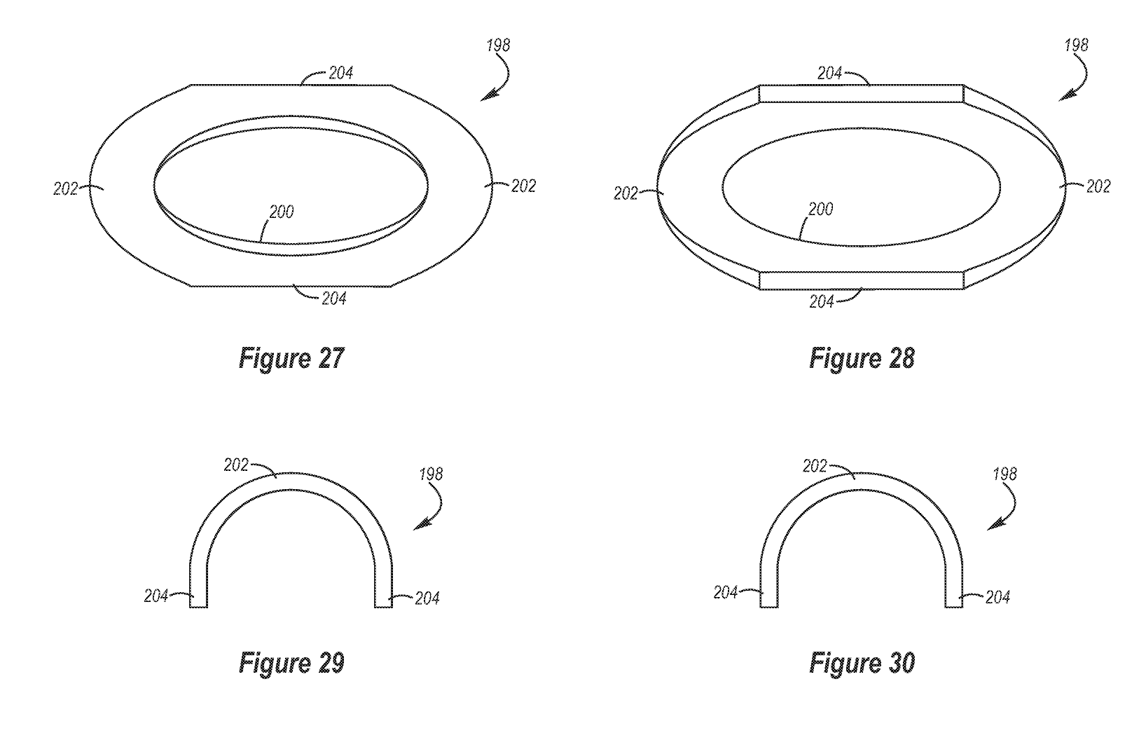

As shown in FIGS. 1-3 and 23-30, the trailer 10 may include one or more anchors or tie downs 198, which may be connected to various portions of the trailer. Tie downs are used to hold down cargo or equipments during transport. In particular, the tie downs 198 may provide a rigid point for securing a binding member (such as, a rope, cable, chain, cord, line and the like) that may be used to secure items carried by the trailer 10.

Advantageously, the binding member may be secured to the anchor 198 in multiple ways. For example, the binding member may be inserted through an opening 200 to facilitate tying and/or securing the binding member to the anchor 198. Also, as best seen in FIGS. 25-26, the anchor 198 may have a generally T-shaped configuration that may include a broader portion 202 and a narrower portion 204, and the binding member may be tied and/or secured to the narrower portion. When the binding member is sufficiently secured to the narrower portion 204, the broader portion 202 may advantageously help restrict the movement of the binding member to help keep the binding member secured to narrower portion. In addition, the narrower portion 204 may be mounted to a portion of the trailer 10 that may also help keep the binding member secured to the narrower portion.

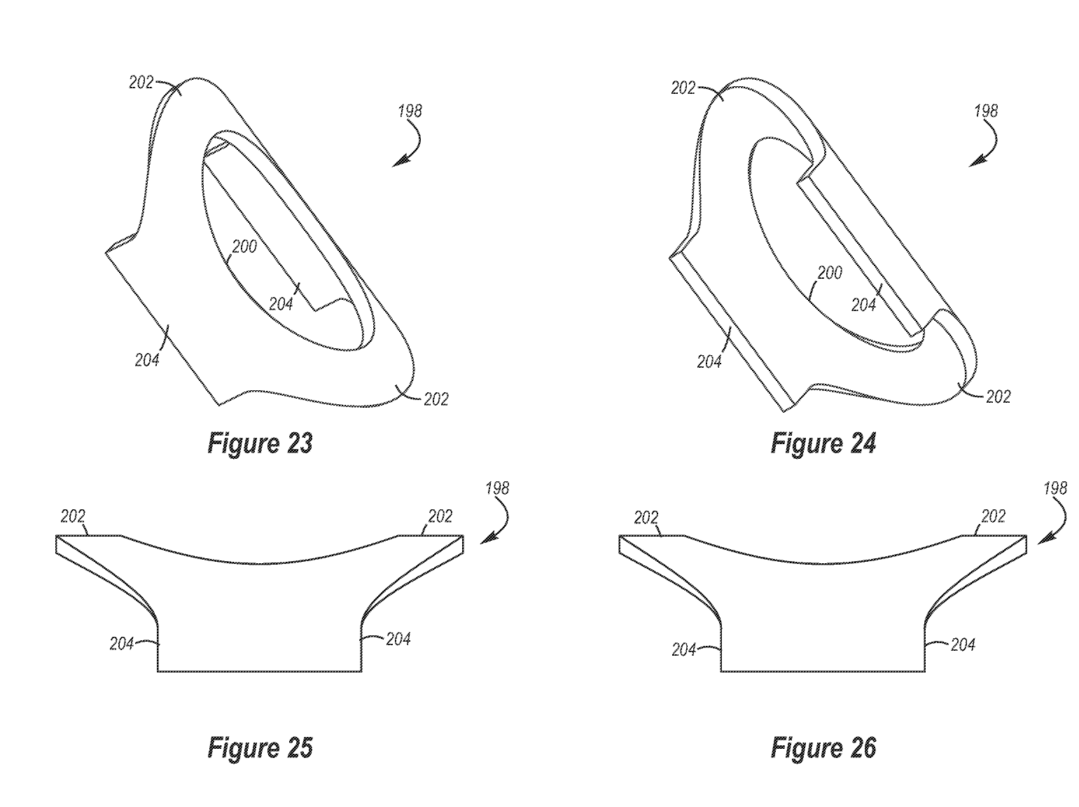

As shown in FIGS. 23-24 and 27-28, the opening 200 may have a generally oval shape and the broader portions 202 may have a generally curved shaped. It will be appreciated, however, that the opening 200, the broader portions 202 and other portions of the anchor 198 may have a variety of other suitable shapes and configurations.

As mentioned above, the trailer 10 can be shipped and/or stored in a relatively small space. Advantageously, this may decrease shipping costs because more trailers 10 may be disposed within a shipping container. In addition, this may reduce storage costs because more trailers 10 can be stored within a given space. Significantly, this may reduce costs because the manufacturer may save on shipping costs. In addition, the retailer may be able to have more trailers in stock because the trailer may be stored in a more compact configuration. Further, the consumer may be able to store the trailer 10 in a smaller area, which may increase the potential number of consumers.

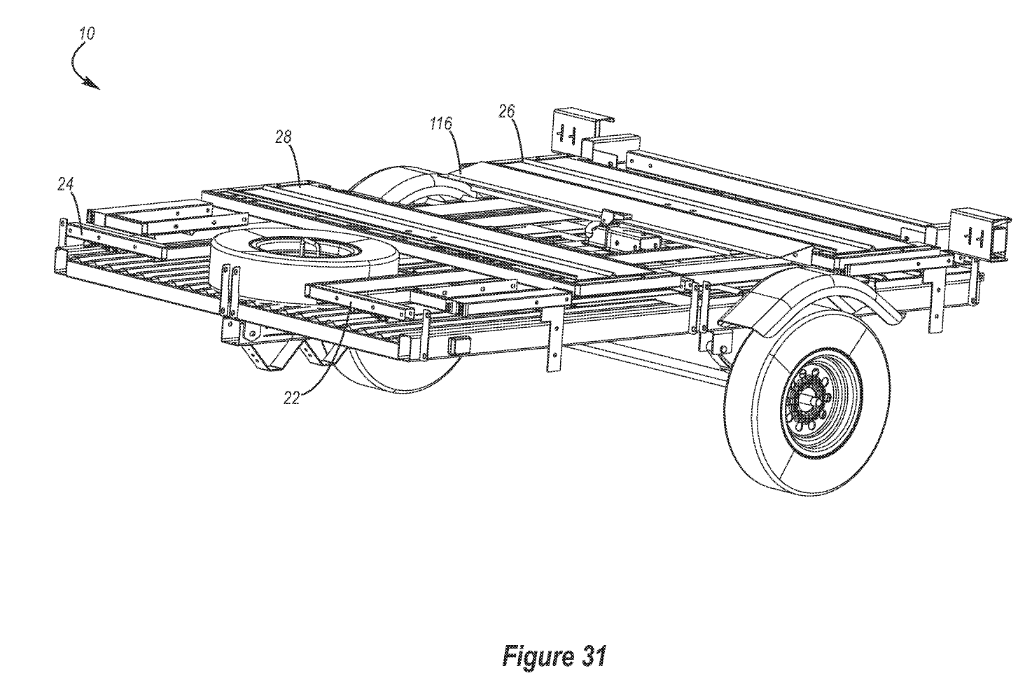

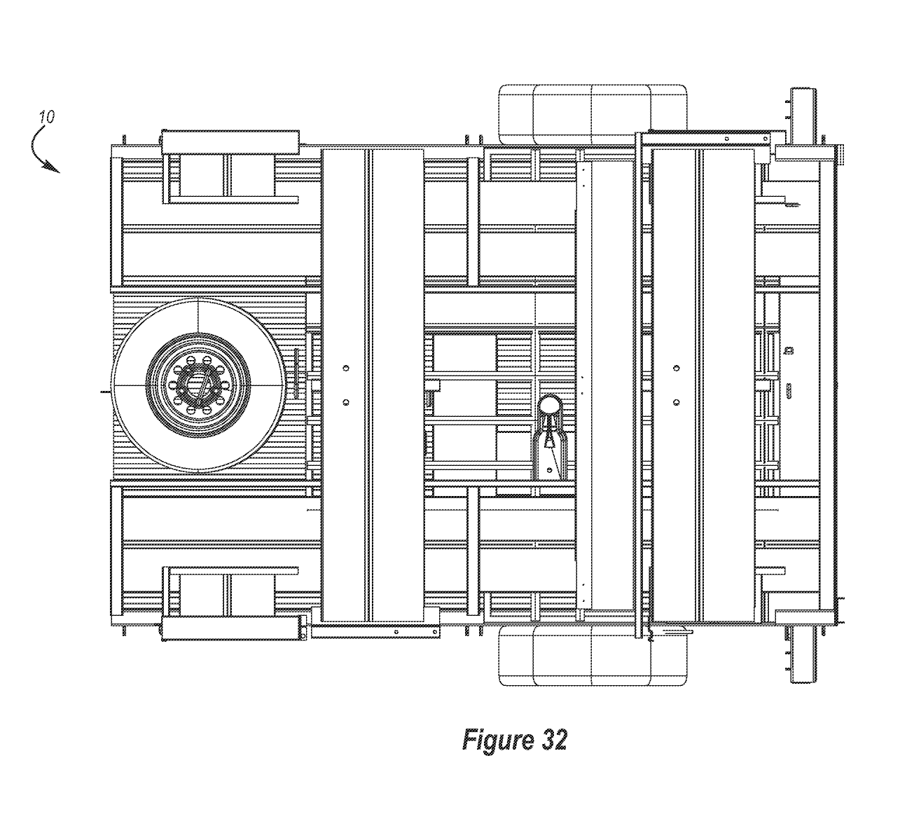

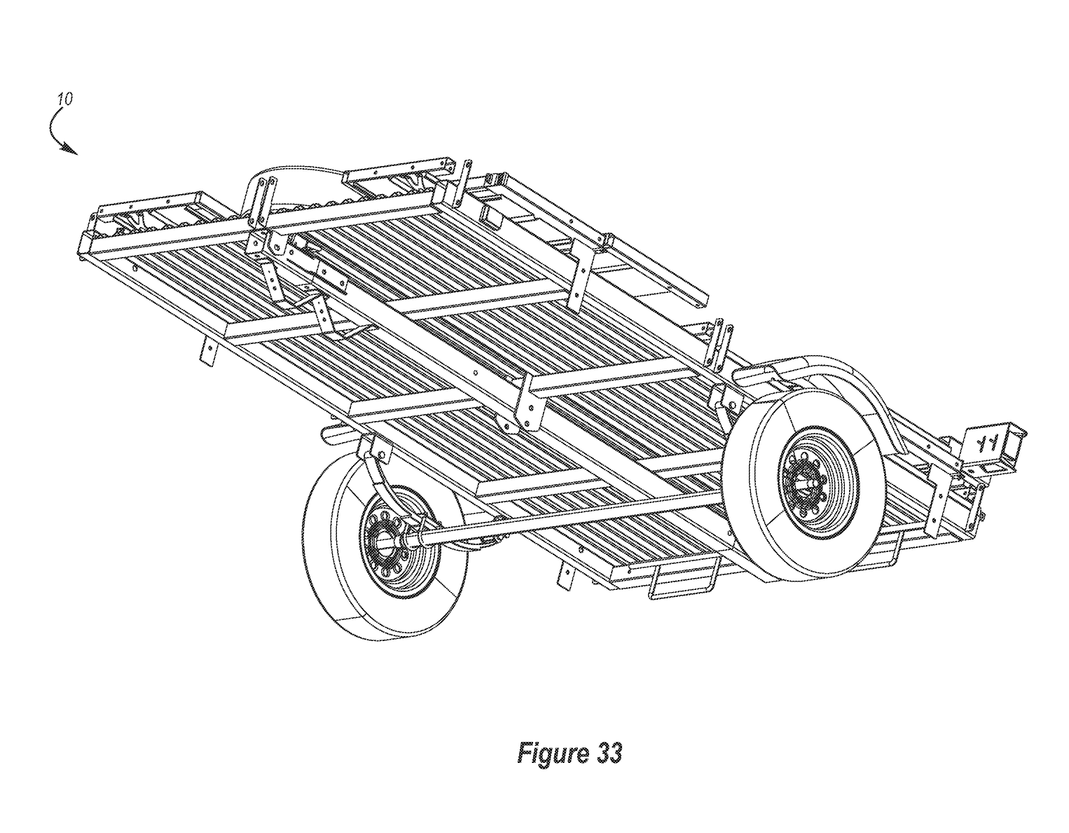

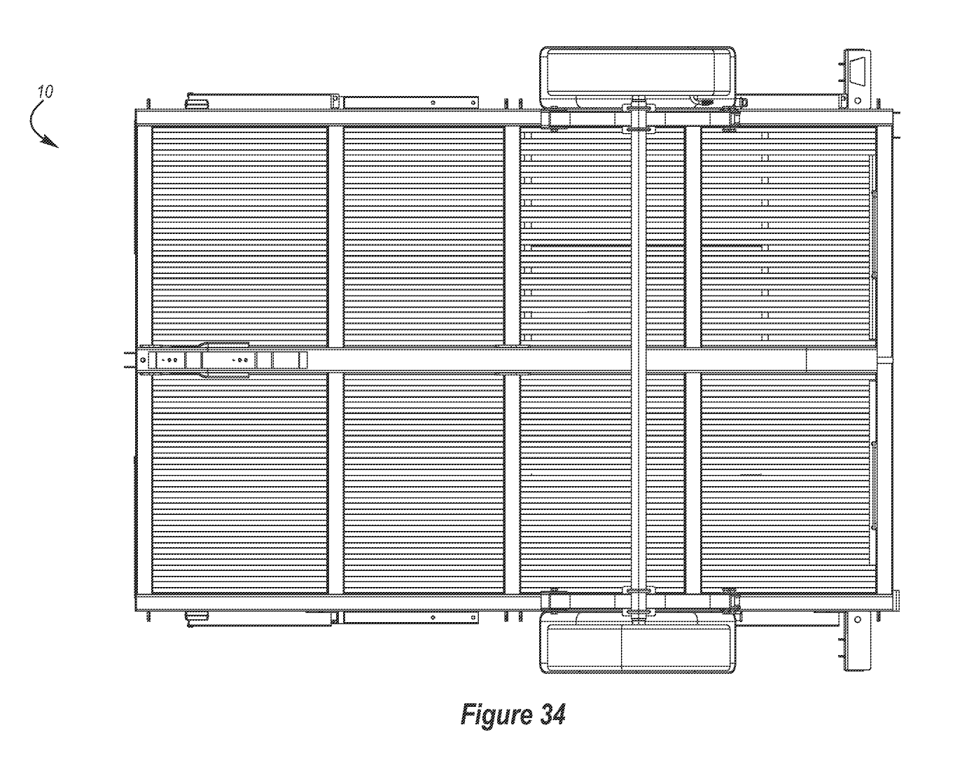

For example, as shown in FIGS. 31-34, the trailer 10 may be positioned in an exemplary shipping configuration. As mentioned above, the trailer 10 desirably includes an extension 116, 118 and the trailer is preferably shipped without the extension connected to the body of the trailer because that may allow the trailer 10 to be shipped in a smaller space and smaller shipping container. In particular, the extensions 116, 118 may allow the trailer 10 to be shipped in a configuration that is less than about 92 inches in length. Of course, the shipping configuration of the trailer 10 may be larger or smaller, if desired.

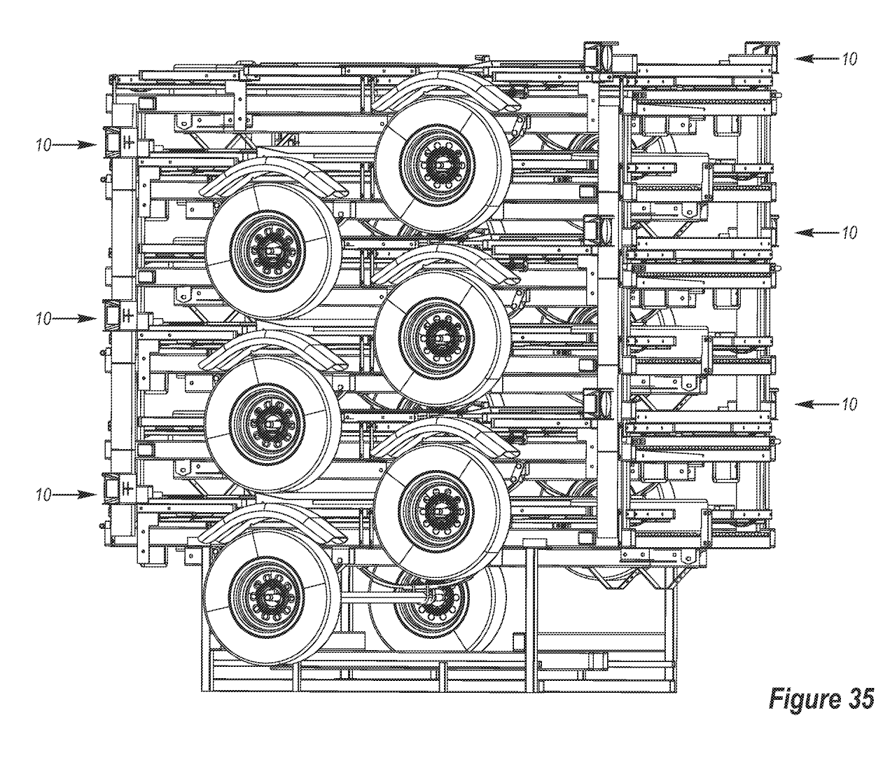

In addition, as shown in FIG. 35, multiple trailers 10 may be stacked upon each other to facilitate shipping. In greater detail, adjacent trailers 10 are preferably disposed in an alternating format so that one trailer faces forwardly and the other trailer faces rearwardly. This may decrease the height of the stacked trailers 10 because the wheels may be offset. Thus, the upper portion of one trailer 10 may be disposed proximate the lower portion of the adjacent trailer.

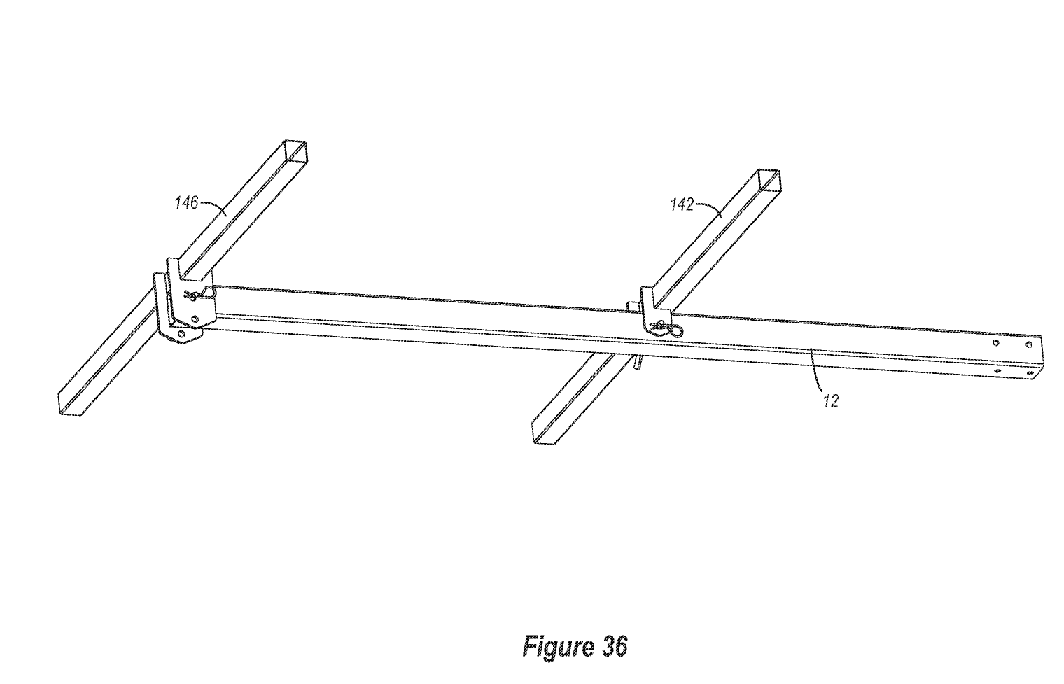

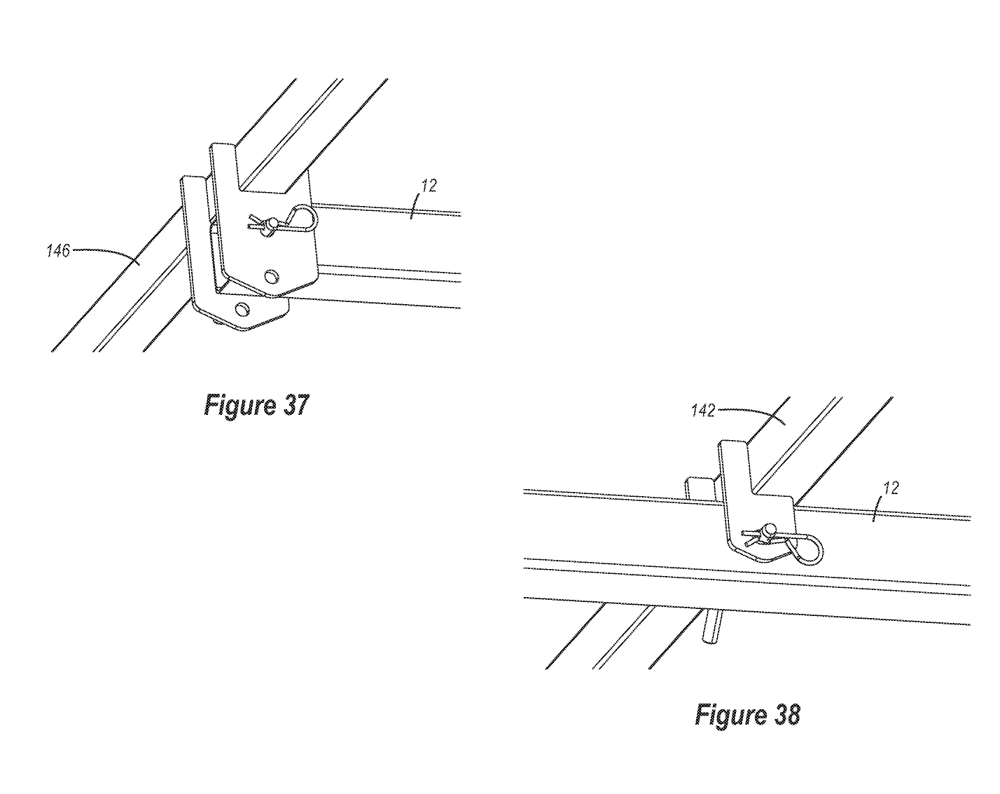

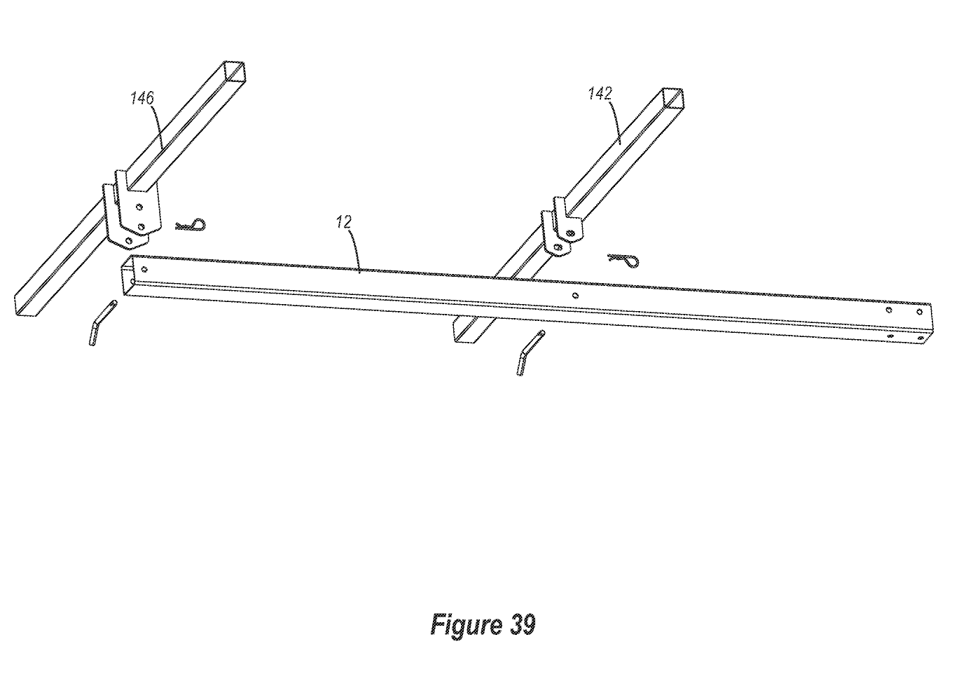

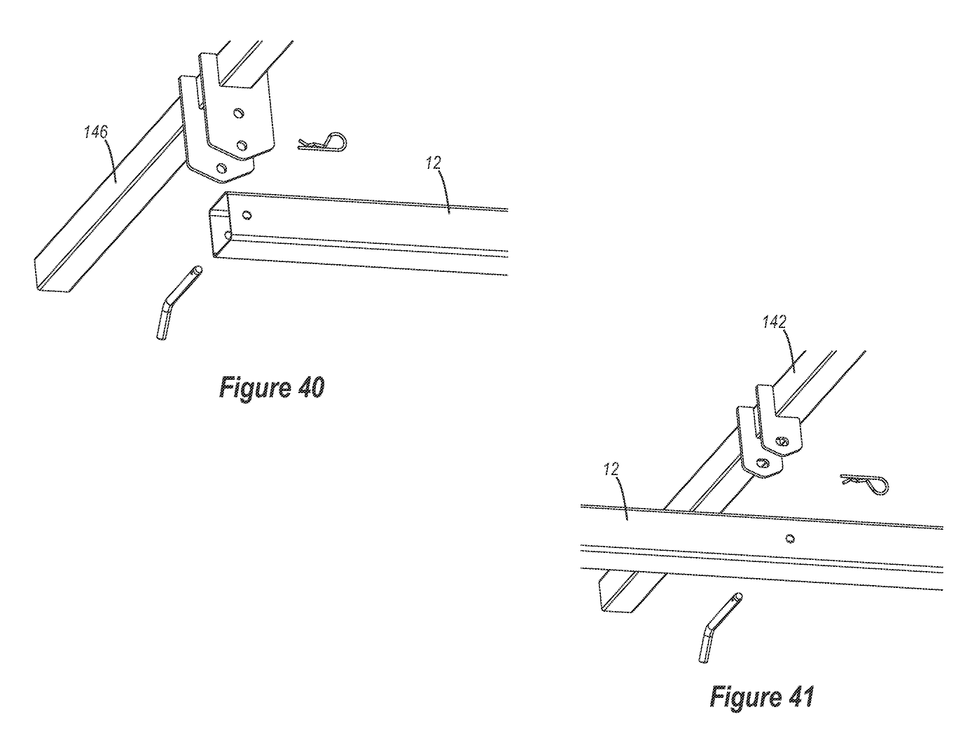

Significantly, the trailers 10 may be stacked so that the ends of the trailers are generally aligned. Advantageously, this may allow the trailers 10 to be shipped in a standard shipping container. In addition, the trailers 10 may be shipped in a substantially assembled configuration, which may allow the trailers to be quickly and easily used. For example, as mentioned above, the arm 12 may be attached to the frame 20 of the trailer 10 using fasteners. In particular, as shown in FIGS. 36-41, a pin may be used to attach the arm 12 to the frame 20 and the pin may be secured in position by a fastener such as a cotter pin. This may allow the arm 12 to be attached to the trailer 10 without tools.

Additionally, when the trailer 10 is in the shipping configuration, such as shown in FIGS. 31-34, the trailer's rear lights (i.e., brake lights, turn signals, etc.) are preferably positioned for use such that the trailer 10 may be ready for towing after positioning the arm 12 in the use position and supplying power to the trailer. That is, the trailer 10 may be shipped with the rear lights in a position that allows the trailer to be immediately used. Thus, the trailer 10 may be towed home in a partially unassembled configuration without tools and then may be fully assembled once at home. For example, the pins shown in FIGS. 36-41 may be replaced with more permanent fasteners and the rear lights may be repositioned after the trailer is towed away from the store.

Further, the arm 12 may form at least a portion of a conduit that may house at least a portion of the wiring used to supply power to the rear lights. In particular, wiring may be disposed within the arm 12 and the wiring may be connected to a trailer light interface provided by the towing vehicle. In addition, as the arm 12 is drawn forward for use, the wire may move from a compacted arrangement to a less compacted arrangement. Thus, the trailer 10 may be shipped with the wiring installed and in place for immediate use.

In addition, when the trailer 10 is in the shipping or storage configuration, various portions of the trailer may be detached and disposed in a more compact arrangement to facilitate shipping or storage. In particular, as best seen in FIG. 31, the barriers 22, 24, 26, 28 and the extension 116 may be disposed in a generally horizontal orientation to help reduce the size of the shipping or storage configuration. The barriers 22, 24, 26, 28 and the extension 116 may also be at least partially unassembled, which may allow their components to be disposed in a generally horizontal orientation to help further reduce the size of the shipping or storage configuration. If desired, the barriers may be pivotally or otherwise movably connected to the trailer, which may allow them to be moved between the generally horizontal orientation for shipping and a generally vertical orientation for use. Of course, the barriers need not be pivotally or otherwise movably connected to the trailer in the shipping or storage configuration, which may allow the barriers to be positioned in a variety of other arrangements. As shown in FIG. 31, a spare tire, a hitch coupler and/or other components of the trailer may be disposed upon the bed and/or other portions of the trailer to provide the compact shipping or storage configuration.

The trailer 10 is preferably constructed from relatively strong and durable materials. For example, the frame 20, barriers 22, 24, 26, 28 and the like are preferably constructed from metal (such as steel), but other relatively strong and durable materials could also be used. It will be appreciated that the trailer 10 may also be constructed from other suitable materials.

It will also be appreciated that the trailer 10 may have other suitable shapes, sizes, arrangements and configurations. In addition, the trailer 10 may have other aspects, features and advantages. In particular, the trailer 10 could have different parts, features, aspects, sizes, shapes, configurations and arrangements depending, for example, upon the intended use of the trailer.

Other suitable aspects, features, configurations and arrangements that may be used in connection with the trailer are shown and described in U.S. provisional patent application Ser. No. 60/749,775, filed Dec. 12, 2005 and entitled TRAILER; U.S. provisional patent application Ser. No. 60/752,194, filed Dec. 20, 2005 and entitled TRAILER; U.S. provisional patent application Ser. No. 60/777,760, filed Mar. 1, 2006 and entitled TRAILER; U.S. provisional patent application Ser. No. 60/810,088, filed Jun. 1, 2006 and entitled TRAILER; U.S. provisional patent application Ser. No. 60/840,849, entitled TRAILER and filed Aug. 29, 2006; U.S. provisional patent application Ser. No. 60/840,893, entitled TRAILER and filed Aug. 29, 2006; U.S. patent application Ser. No. ______, entitled TRAILER and filed Dec. 11, 2006, (Attorney Docket No. 15499.807.4); U.S. patent application Ser. No. ______, entitled TRAILER and filed Dec. 11, 2006, (Attorney Docket No. 15499.823.2); U.S. patent application Ser. No. ______, entitled TRAILER and filed Dec. 11, 2006, (Attorney Docket No. 15499.846); U.S. patent application Ser. No. ______, entitled TRAILER and filed Dec. 11, 2006, (Attorney Docket No. 15499.847); U.S. patent application Ser. No. ______, entitled TRAILER and filed Dec. 11, 2006, (Attorney Docket No. 15499.848); U.S. patent application Ser. No. ______, entitled TRAILER and filed Dec. 11, 2006, (Attorney Docket No. 15499.894); the disclosures of each of these applications are incorporated by reference in their entireties.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method for using a trailer, the method comprising:
using a first set of one or more fasteners to secure a towing arm to a frame of a partially unassembled trailer;
towing the partially unassembled trailer by the towing arm; and
after towing the partially unassembled trailer by the towing arm, replacing at least one of the first set of one or more fasteners with a second set of one or more fasteners to secure the towing arm to the frame.

2. The method as in claim 1, wherein the first set of one or more fasteners are sized and configured to receive a portion of a cotter pin to secure the towing arm to the frame.

3. The method as in claim 1, further comprising, before towing the partially unassembled trailer by the towing arm, connecting at least one light of the partially unassembled trailer to a trailer light interface provided by a towing vehicle.

4. The method as in claim 3, wherein the towing arm forms at least a portion of a conduit; and wherein at least a portion of a wire connecting the at least one light and the trailer light interface is housed within the conduit.

5. A method for using a trailer, the method comprising:
using a first set of one or more fasteners to secure a towing arm to a trailer, the first set of one or more fasteners being sized and configured to receive a portion of a cotter pin to secure the towing arm to the trailer;
towing the trailer by the towing arm from a first location to a second location; and
after towing the trailer by the towing arm, replacing at least one of the first set of one or more fasteners with a second set of one or more fasteners to secure the towing arm to the trailer.

6. The method as in claim 5, further comprising, before towing the trailer by the towing arm, connecting at least one light of the trailer to a trailer light interface provided by a towing vehicle.

7. The method as in claim 6, wherein the towing arm forms at least a portion of a conduit; and wherein at least a portion of a wire connecting the at least one light and the trailer light interface is housed within the conduit.

8. The method as in claim 5, wherein the first location is a store from which a purchaser has purchased the trailer; and wherein the second location is the purchaser's residence.
